(19) United States
(12) Patent Application Publication
(10) Pub. No.: US 2019/0042826 A1
(43) Pub. Date: Feb. 7, 2019

(54) AUTOMATIC NUCLEI SEGMENTATION IN HISTOPATHOLOGY IMAGES

(71) Applicant: OREGON HEALTH & SCIENCE UNIVERSITY, Portland, OR (US)

(72) Inventors: Young Hwan Chang, Portland, OR (US); Guillaume Thibault, Portland, OR (US)

(73) Assignee: OREGON HEALTH & SCIENCE UNIVERSITY, Portland, OR (US)

(21) Appl. No.: 16/054,833

(22) Filed: Aug. 3, 2018

Related U.S. Application Data
(60) Provisional application No. 62/541,475, filed on Aug. 4, 2017.

(51) Int. Cl. G06K 9/00; G06T 7/00; G06T 7/11; G06K 9/46; G06T 7/44

(52) U.S. Cl. CPC G06K 9/0014; G06T 7/0012; G06T 7/11; G06T 2207/30024; G06T 7/44; G06T 2207/10056; G06K 9/4638

(57) ABSTRACT

Provided herein are systems and computer-implemented methods for quantitative analyses of tissue sections (including, histopathology samples, such as immunohistochemically labeled or H&E stained tissue sections), involving automatic unsupervised segmentation of image(s) of the tissue section(s), measurement of multiple features for individual nuclei within the image(s), clustering of nuclei based on extracted features, and/or analysis of the spatial arrangement and organization of features in the image based on spatial statistics. Also provided are computer-readable media containing instructions to perform operations to carry out such methods. A quantitative image analysis pipeline for tumor purity estimation is also described

### CROSS-REFERENCE TO RELATED APPLICATION

This application claims the benefit of the earlier filing date of U.S. Provisional Application No. 62/541,475, filed Aug. 4, 2017, which earlier application is herein incorporated by reference in its entirety.

### FIELD

Generally, this disclosure relates to image analysis, particularly analysis of cytological samples, including histochemistry such as multiplexed histochemistry. More specifically, the disclosure relates to the fields of automated cell analysis and classification.

### BACKGROUND OF THE DISCLOSURE

In the task of grading or diagnosis of diseases in histopathology images, e.g., cancer, the identification of certain histological structures such as nuclei, lymphocytes, and glands is essential. For example, cell counts may have diagnostic significance for some cancerous conditions (Gurcan et al., Biomedical Engineering, IEEE Reviews, 2: 147-171, 2009; Irshad et al., Biomedical Engineering, IEEE Reviews, 7: 97-114, 2014). A low Gleason score means that the cancer tissue is similar to normal prostate tissue and the tumor is less likely to spread. In Beck et al. (Science Translational Medicine, 3(108): 108ra113, 2011), the authors found that stromal features are significantly associated with survival and these findings implicate stromal morphologic structure as a previously unrecognized prognostic determinant for breast cancer.

Therefore, the shape, size, extent, and other morphological appearance of histological structures can be used as indicators for presence or grade of disease and thus, it is important to have the ability to automatically identify these structures. In the past decade, the development of generic and robust cell segmentation methods has intensified (Meijering et al., Signal Processing Magazine, IEEE, 29: 140-145, 2012). Automated cell image analysis methods have been proposed which allow accurate identification and quantitative measurement of cells' features (Jones et al., PNAS, 106(6): 1826-1831, 2009). Despite these advances, general cellular heterogeneity has remained a significant bottleneck in automated cell image analysis.

### BRIEF DESCRIPTION

Recently, machine learning approaches have been used for automated cell classification by selecting and combining multiple features (Beck et al., Science Translational Medicine, 3(108): 108ra113, 2011; Jones et al., PNAS, 106(6): 1826-1831, 2009), but they require the segmented cells be assessed by a pathologist visually examining individual cells. This is time-consuming and often infeasible for large-scale studies.

The current disclosure provides systems and methods for automatically segmenting nuclei in histopathology images. In particular embodiments, automatic nuclei segmentation includes mapping the pixels of a histopathology image to a point on an n-dimensional feature space; representing pixels as super-pixels including data of one or more chosen features; and clustering neighboring pixels with similar features.

Particular embodiments include extracting cytological profiles for individual cells to classify cell types. In particular embodiments, cytological profiling and clustering include measuring various features selected from one or more of area, major/minor axis length, perimeter, equivalent diameter, shape indices (e.g., eccentricity, Euler number, extent, solidity, compactness, circularity, or aspect ratio) and intensity. The selected and measured features can be used to cluster individual segmented nuclei into different types.

Particular embodiments include pixel level features extraction (e.g., wavelets response for parameters) followed by clusterings (e.g., iterations until convergence of k-means). This combination is more robust, stable, and effective than the current state of the art.

Particular embodiments include use of the spatial arrangement of nuclei to characterize the spatial distribution of different cell types within different regions of a sample.

Particular embodiments include new approaches for quantitative analysis on histopathology (e.g., hematoxylin and eosin [H&E] or immunohistochemistry [IHC] stained) tissue sections: (a) an automatic unsupervised segmentation, (b) measurement of multiple features for individual nuclei, (c) effectively clustering the nuclei based on the measured features and (d) analyzing the spatial arrangement and organization based on spatial statistics. Unlike other approaches, in particular embodiments, the systems and methods are fully automatic and require no externally-provided label information.

The disclosed systems and methods can be used to provide tumor purity scoring. In particular embodiments, systems and methods that provide tumor purity scoring can include the steps of segmentation and classification. In particular embodiments, systems and methods that provide tumor purity scoring can include the steps of annotation, segmentation, and classification.

This brief description is intended only to provide a brief overview of subject matter disclosed herein according to one or more illustrative embodiments, and does not serve as a guide to interpreting the claims or to define or limit scope, which is defined only by the appended claims. This brief description is provided to introduce an illustrative selection of concepts in a simplified form that are further described below in the Detailed Description. This brief description is not intended to identify key features or essential features of the claimed subject matter, nor is it intended to be used as an aid in determining the scope of the claimed subject matter. The claimed subject matter is not limited to implementations that solve any or all disadvantages noted in the Background or elsewhere in this document.

### BRIEF DESCRIPTION OF THE SEVERAL VIEWS OF THE DRAWINGS

This application contains at least one drawing executed in color. Copies of this application with color drawing(s) will be provided by the Office upon request and payment of the necessary fee. At least some of the drawings submitted herein are better understood in color. Applicant considers the color versions of the drawings as part of the original submission and reserve the right to present color images of the drawings in later proceedings. Applicant hereby incorporates by reference the color drawings filed herewith and retained in SCORE. The attached drawings are for purposes of illustration and are not necessarily to scale.

FIG. 1 is a dataflow diagram of example process.

FIG. 2. (left) Conceptual diagram of nuclei segmentation (right) Intratumoral heterogeneity: examples of different classes of cell nuclei (tumor cells/normal cells/lymphocytes).

FIG. 3A-3G. Examples of spatial point patterns and comparability of a point process with CSR: (FIG. 3A) CSR point process (FIG. 3B) cluster point pattern (FIG. 3C) point pattern exhibiting regularity. Under CSR, an event has the same probability of occurring at any location in R, and events neither inhibit (i.e., regularity) nor attract each other (i.e., clustering) (FIGS. 3D-3G) G-, F-, K- and L-distributions.

FIG. 4. Validation of segmentation result with matched immunofluorescence: H&E stained section, DAPI (ground truth), segmented nuclei (Segmentation) and overlapped region (Overlay, red color: perfect match, green: only H&E, blue: only DAPI). Note that only a small region is shown due to the space constraints.

FIG. 5. A covered area ratio subjected to a particular cluster in each H&E stained section. Within the same cluster, cytoprofiles of segmented nuclei show similar characteristics.

FIG. 6. The segmented nuclei (color-coded according to their clusters) and the second-order spatial statistics (L-function): (left) tumor cell region (cluster 2, 3) (middle) normal cell region (cluster 3, 4) (right) lymphocyte region (cluster 2, 5). Not surprisingly, higher nuclei clustering was found in tumor region compared with normal cell or lymphocyte region, possibly due to the aggregated patterns of tumor cells. Note that only two dominant clusters for each region are shown so there are some nuclei which are not color-coded.

FIG. 7. Review of data presented in Example 1. (left) Three representative regions such as tumor cell, normal cell and lymphocyte region (right) were selected. Higher nuclei clustering was found in tumor region compared with normal cell or lymphocyte region based on L^{∧} function, possibly due to the aggregated patterns of tumor cells.

FIG. 8. (top) is a series of images of different regions chosen from the whole slide section. (bottom) is a series of graphs showing population density and spatial similarity analysis (S1 versus S2) for tumor cell region and normal cell region, where values below the dashed line on the bottom (0.05) denotes the significant clustered pattern at the 95 percent confidence interval and values above the red dashed line at the top (0.95) denotes significant dispersion at the 95 percent confidence interval.

FIG. 9 is a conceptual illustration of a herein described pipeline: histopathology image annotation, segmentation, feature extraction, classification, and tumor purity calculation.

FIG. 10 shows image patch for texture feature extraction where red boundaries represent individual segmented nuclei and blue boundaries represent separation of touching nuclei using watershed algorithm: (left) initial patch for texture feature extraction based on the bounding box of segmented nuclei; (right) fixed size patch centered at centroids of segmented nuclei allows for context-specific feature extraction and increases classification accuracy.

FIG. 11A-11D shows an example of a prediction result from a test data set: (FIG. 11A and FIG. 11C) Nuclei that have been annotated with pathologists' labels overlaid on top of the nuclei segmentation. (FIG. 11B and FIG. 11D) Classes predicted by the SVM classifier for annotated nuclei. In all panels, cancerous nuclei are outlined in yellow; non-cancerous nuclei are outlined in cyan. (Lack of an outline for some nuclei represent nuclei without pathologists' annotations).

FIG. 12 is a graph showing a tumor purity comparison where α=0.5688 with 95% confidence bounds.

FIG. 13 is a high-level diagram showing components of an example image-analysis system.

### DETAILED DESCRIPTION

The preparation of histopathological slides is a technique which is well known in the art. In brief, histopathological analysis of tissue begins with the removal of the tissue from a subject, for example, by surgery, biopsy, or autopsy. Histology specimen preparation follows the general process of fixation, embedding, mounting, and staining: fixation stops metabolic processes in cells and preserves cell structure; embedding allows the specimen to be sliced into thin sections (usually 5-15 μm); mounting fixes the thin section to a slide; and staining colors the otherwise colorless cellular material for viewing under a microscope, and provides the ability to highlight certain molecular characteristics.

To immuno-stain histology samples, tissues of a tissue section (such as a paraffin, fixed, unfixed, or frozen section) on a microscope slide are treated with an antibody that binds to the specific target protein. The antibodies are conjugated to a label that renders tissues that bound to the label visible under a microscope. Examples of labels that may be used in immunohistochemistry (IHC) include fluorescent dyes, radioisotopes, metals (such as colloidal gold), and enzymes that produce a local color change upon interaction with a substrate. Multiple molecules may be assessed in the same tissue using differentially labeled antibodies—for example, by using a first antibody specific for a first molecule conjugated to a label that fluoresces at a particular wavelength and a second antibody specific for a second molecule conjugated to a label that fluoresces at a different wavelength than the one conjugated to the first molecule.

A routinely used stain system in histopathology is a combination of hematoxylin and eosin (H&E). Hematoxylin is used to stain nuclei blue, while eosin counter-stains other eosinophilic structures, such as cytoplasm and the extracellular connective tissue matrix, in various shades of red, pink, and orange. However, other stains which are well known in the art can also be used to selectively stain cells, such as safranin, Oil Red O, congo red, silver salts, DAB stain, PAS stain, and other dyes. In certain embodiments, the histopathological slide to be initially analyzed is stained with H&E.

The cellular heterogeneity and complex tissue architecture of most samples, e.g., tumor or other samples, is a major obstacle in image analysis on standard hematoxylin and eosin-stained (H&E) tissue sections. Although staining of histopathological slides, for example using H&E, enables better visualization of tissue structures, as the stain used may cause variation in terms of color and intensity between different images, pre-processing of an image may be required to achieve a consistent color and intensity appearance. In some embodiments, the color and intensity of a stained image is normalized using any method known in the art, for example, by using the method of D. Magee et al. (Proceedings Medical Image Understanding and Analysis (MIUA), 1-5, 2010).

Optimized sequential IHC detection with iterative labeling, digital scanning, and subsequent stripping of tissue sections, to enable simultaneous evaluation of at least 12 biomarkers in a single formalin fixed paraffin embedded (FFPE) tissue section, has been described in US 2017/0160171, incorporated herein by reference. Particular embodiments included evaluation of up to 60 biomarkers in a FFPE tissue section. The herein-disclosed systems and methods can be used in combination with the disclosure of US 2017/0160171.

In general, the analysis of H&E sections can be divided into mainly two different approaches (Gurcan et al., Biomedical Engineering, IEEE Reviews, 2: 147-171, 2009; Irshad et al., Biomedical Engineering, IEEE Reviews, 7: 97-114, 2014), some researchers advocate nuclei segmentation and classification; other groups focus on patch level analysis (e.g., small regions) for pathology detection.

Local, Structural Segmentation.

The problem of cell segmentation has received increasing attention in past years and several automated cell segmentation methods have been proposed (Meijering et al., Signal Processing Magazine, IEEE, 29: 140-145, September 2012). Most methods use a few basic algorithms for cell segmentation, such as automatic intensity thresholding, filtering, morphological operations, region accumulation, or deformable models (Irshad et al., Biomedical Engineering, IEEE Reviews, 7: 97-114, 2014). The majority of these approaches treat microscopy images in the same way as techniques for segmenting natural images. Also, methods proposed in recent times are often merely new combinations of the existing approaches, but these approaches are limited to a specific application.

Large Scale (Patch-Level) Analysis.

Some researchers focus on patch level analysis for tumor representation and classification of histology sections. Image patch classification is an important task in many different medical imaging applications. For example, in Bianconi et al. (Neurocomput., 154: 119-126, 2015), the authors propose the use of image features for discriminating epithelium and stroma in histological sections. In Li et al. (Engineering in Medicine and Biology Society (EMBC), 2013 35th Annual International Conference of the IEEE: 6079-6082, July 2013), the authors perform image patch classification to differentiate various lung tissue patterns. These methods are mostly focused on feature design including texture features, object-level features, and graphs features. Also, various classifiers (Bayesian, k-nearest neighbors, support vector machine, etc.) are investigated in a supervised fashion with labeled data.

Some tissues or other samples include multiple types of cells, e.g., a mixture of cancer and normal cells. Such mixtures complicate the interpretation of cytological profiles. Furthermore, spatial arrangement and architectural organization of cells are generally not reflected in cellular characteristics analysis.

In a first embodiment, there is provided a system, including: an image-capture device configured to capture an image of a cell population, the image including input-pixel values of respective pixels of the image; and a control unit operatively connected with the image-capture device and configured to: determine a feature image based at least in part on the input-pixel values, the feature image including per-pixel feature values associated with respective pixels of the pixels of the image; determine a plurality of clusters based at least in part on the feature image, each cluster of the plurality of clusters associated with at least some of the pixels of the image; select a first cluster of the plurality of clusters, the first cluster associated with nuclei of cells in the cell population; determine a nuclei mask image representing pixels of the image associated with the first cluster; and determine a plurality of per-nucleus mask images by applying morphological operations to the nuclei mask image.

In another embodiment there is provided a computer-implemented method, including: capturing an image of a cell population, the image including input-pixel values of respective pixels of the image; determining a feature image based at least in part on the input-pixel values, the feature image including super-pixels associated with respective pixels of the pixels of the image, wherein each super-pixel includes one or more per-pixel feature value(s) associated with the respective pixel of the pixels of the image; determining a plurality of clusters based at least in part on the feature image, wherein each cluster of the plurality of clusters is associated with at least some of the pixels of the image; selecting a first cluster of the plurality of clusters, the first cluster associated with nuclei of cells in the cell population; determining a nuclei mask image representing pixels of the image associated with the first cluster; and determining a plurality of per-nucleus mask images by applying one or more morphological operations to the nuclei mask image.

Yet another embodiment is a computer-readable medium, having thereon computer-executable instructions, the computer-executable instructions upon execution configuring a computer to perform operations including: capturing an image of a cell population, the image including input-pixel values of respective pixels of the image; determining a feature image based at least in part on the input-pixel values, the feature image including super-pixels associated with respective pixels of the pixels of the image, wherein each super-pixel includes one or more per-pixel feature value(s) associated with the respective pixel of the pixels of the image; determining a plurality of clusters based at least in part on the feature image, wherein each cluster of the plurality of clusters is associated with at least some of the pixels of the image; selecting a first cluster of the plurality of clusters, the first cluster associated with nuclei of cells in the cell population; determining a nuclei mask image representing pixels of the image associated with the first cluster; and determining a plurality of per-nucleus mask images by applying one or more morphological operations to the nuclei mask image.

Particular embodiments include new approaches for quantitative analysis on histopathology (e.g., H&E or IHC) tissue sections: (a) an automatic unsupervised segmentation, (b) measurement of multiple features for individual nuclei, (c) effectively clustering the nuclei based on the extracted features, and (d) analyzing the spatial arrangement and organization based on spatial statistics. Unlike other approaches, in particular embodiments, the systems and methods are fully automatic and require no label information.

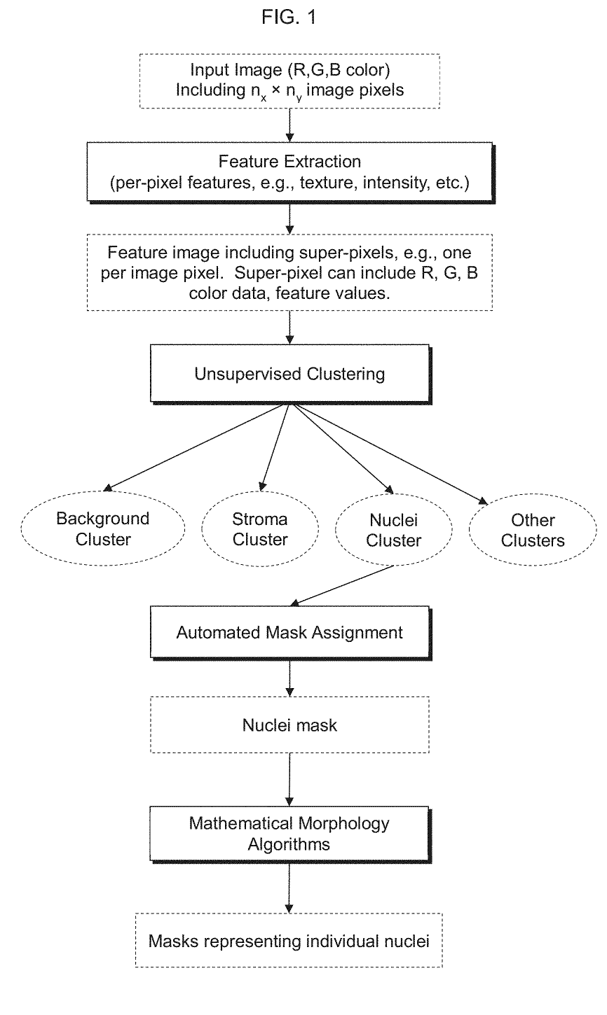

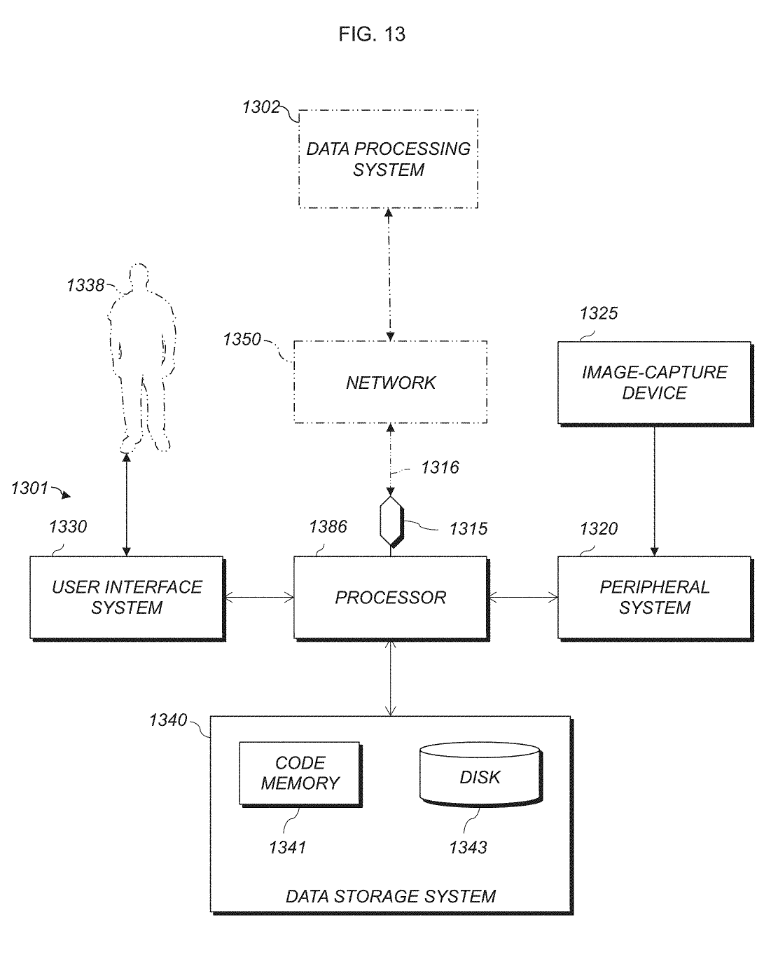

In particular embodiments, an image of stained tissue is captured, transformed into data, and transmitted to a biological image analyzer (e.g., as shown in FIG. 13) for analysis. The biological image analyzer can include processor(s) and memory coupled to the processor(s), the memory to store computer-executable instructions that, when executed by the processor, cause the processor to perform operations disclosed herein (e.g., as shown in FIG. 1). For example, the stained tissue may be viewed under a microscope, digitized, and either stored onto a non-transitory computer readable storage medium or transmitted as data directly to the biological image analyzer for analysis. As another example, a picture of the stained tissue may be scanned, digitized, and either stored onto a non-transitory computer readable storage medium or transmitted as data directly to a computer system for analysis.

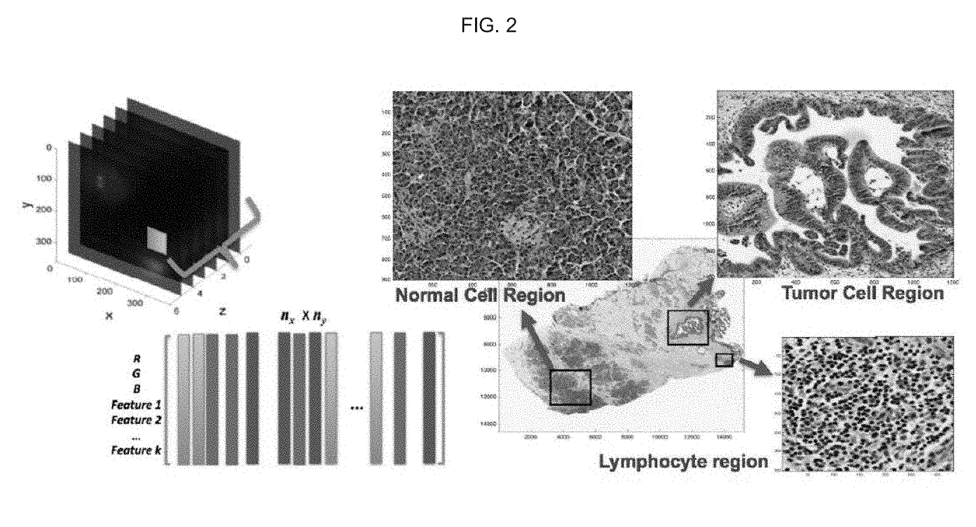

Particular embodiments include automatically segmenting nuclei in histopathology images. In particular embodiments, automatic nuclei segmentation includes mapping the pixels of a histopathology image to a point on an n-dimensional feature space; determining super-pixels including data on one or more chosen features, each super-pixel associated with at least one pixel; and clustering neighboring pixels with similar features. In some examples, a super-pixel can include at least one of: an R, G, B, Panchromatic (broadband), C, M, Y, Cb, Cr, CIE L*, CIE a*, CIE b*, or other data value of or determined based on a corresponding pixel, e.g., as captured by image-capture device 1325, FIG. 13; a Gabor filter response associated with that pixel; a Haralick feature value associated with that pixel; or another feature value associated with that pixel. In the example of FIG. 2, each super-pixel (nₓ×n_{y} in number) includes R, G, and B components, and values for features 1-k. For brevity, a “super-pixel image” refers to a group of super-pixels corresponding with pixels of a captured image, regardless of whether those super-pixels are assembled in a two-dimensional matrix and regardless of whether those super-pixels are presented via a display or other user-interface devices.

In particular embodiments, individual pixels can be clustered based on a representative morphological feature using Gabor filters. A Gabor feature is, for example, a feature of a digital image having been extracted from the digital image by applying one or more Gabor filters on the digital image. The one or more Gabor filters may have different frequencies and/or orientations. A Gabor filter is, for example, a linear filter that can be used for detecting patterns in images, e.g. for detecting edges. Frequency and orientation representations of Gabor filters are similar to those of the human visual system, and they have been found to be useful for texture representation and discrimination. For example, a Gabor filter can be a Gaussian (or other) kernel function modulated by a sinusoidal plane wave having a particular angle and spatial frequency. A Gabor filter can be applied to an image by convolving the image with the filter. The result can be an image that, e.g., has higher intensity values along edges aligned with the filter than along edges aligned in other directions. Some examples convolve the image with log-Gabor filters in a plurality of different orientations and at different scales (spatial frequencies), and then average the responses of the different orientations at the same scale to obtain rotation-invariant features. Some examples apply multiple Gabor filters to an image to provide corresponding Gabor-space values for the pixels of the image. The Gabor-space values for a particular pixel are then aggregated into a super-pixel, so that the super-pixel includes each of the Gabor-space values for the image pixel as separate features. More information on Gabor filters and their application may be found in Jain & Farrokhnia (IEEE Int. Conf. System, Man., Cyber., 14-19, 1990), the disclosure of which is hereby incorporated by reference in its entirety herein. Again, these features may be supplied to the classification module.

Other filtering methods may also be used. For example, Haralick features can capture information patterns or characteristics of textures appearing in images. The Haralick texture values are computed from a co-occurrence matrix. This matrix is defined for a predetermined offset; multiple matrices can be computed, one for each offset (combination of one or more angles with one or more distances). Each cell of a co-occurrence matrix indicates the number of occurrences of a pixel-intensity relationship between two pixels separated by the given offset. For example, cell (2,3) in the matrix for offset (4,0) contains the pixel pairs in the image in which the pixels are on the same row, the pixels are separated by 4 pixels horizontally, one of the pixels has intensity value 2, and the other of the pixels has intensity value 3. Co-occurrence matrices can be computed for color images, e.g., by converting to grayscale (e.g., the Y component of YCbCr), and then computing the co-occurrence matrices on the converted grayscale image to provide gray-level co-occurrence matrices.

To calculate the Haralick features, in some examples, the co-occurrence matrix can be normalized by basing the intensity levels of the matrix on the maximum and minimum intensity observed within each object identified in the digital image. Haralick et al. (1973) refer to this as a “gray-tone spatial-dependence matrix.” Particular embodiments consider four directions (0°, 45°, 90°, and 135°) between pixels that are separated by some distance, d. (See Haralick et al., IEEE Transactions on Systems, Man, and Cybernetics 3(6): 610-621, 1973.) Haralick features can include, e.g., angular second moment, contrast, correlation, variance, inverse difference moment, sum average, sum variance, sum entropy, entropy, difference variance, difference entropy, and the two information measures of correlation. Haralick features can also include the means or ranges of any of those over multiple angles at a given distance.

Particular embodiments include use of the spatial arrangement of nuclei to characterize the spatial distribution of different cell types within a sample. To support these embodiments, spatial statistics are used for analyzing spatial arrangement and organization, which are not detectable by individual cellular characteristics. The quantitative, spatial statistics analysis can refine and complement cellular characteristics analysis.

The disclosed systems and methods were validated by comparing segmentation result to the ground truth immunofluorescence marker (DAPI). It was also demonstrated that spatial statistics complement cellular characteristics analysis by distinguishing different spatial arrangements along different cell types.

Aspects of the current disclosure are described in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be, a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, messages, data, values, elements, symbols, characters, terms, numbers, numerals, and/or the like. It will be understood, however, that all of these and similar terms are to be associated with appropriate physical quantities and are merely convenient labels.

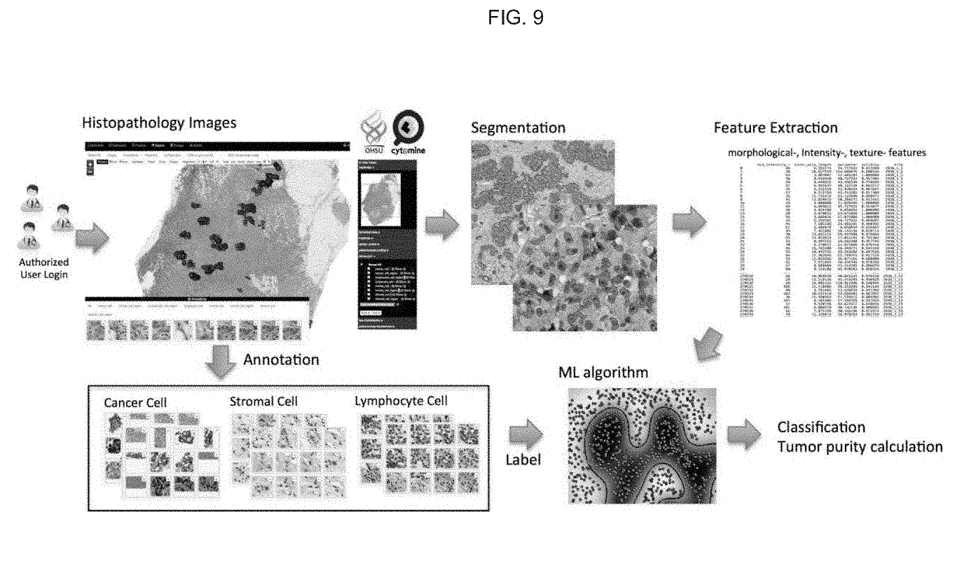

FIG. 13 is a high-level diagram showing the components of an example image-analysis system 1301 for analyzing images and performing other analyses described herein, e.g., with respect to any or all of Examples 1-3, and related components. The system 1301 includes a processor 1386, a peripheral system 1320, a user interface system 1330, and a data storage system 1340. The peripheral system 1320, the user interface system 1330, and the data storage system 1340 are communicatively connected to the processor 1386. Processor 1386 can be communicatively connected to network 1350 (shown in phantom), e.g., the Internet or a leased line, as discussed below. The “CYTOMINE” user interface shown in FIG. 9, for example, can include or be implemented using one or more of systems 1386, 1320, 1330, 1340, and can connect to one or more network(s) 1350. Processor 1386, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1386 can implement processes of various aspects described herein. Processor 1386 and related components can, e.g., carry out processes shown in FIG. 1 or 9, or described herein with reference to Example 1, Example 2, or Example 3. Processor 1386 can, e.g., compute Gabor features, Haralick features, or other image features; determine a nuclei mask (or a mask representing other types of objects) by clustering a feature image; segment the nuclei mask into per-nucleus masks using morphological techniques; determine properties of the spatial distribution of nuclei; or estimate tumor purity in a sample.

Processor 1386 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 1320, user interface system 1330, and data storage system 1340 are shown separately from the data processing system 1386 but can be stored completely or partially within the data processing system 1386.

The peripheral system 1320 can include or be communicatively connected with one or more devices configured or otherwise adapted to provide digital content records to the processor 1386 or to take action in response to processor 186. For example, the peripheral system 1320 can include digital still cameras, digital video cameras, cellular phones, or other data processors. The processor 1386, upon receipt of digital content records from a device in the peripheral system 1320, can store such digital content records in the data storage system 1340.

An imaging apparatus can include one or more image capture devices 1325. Image capture devices 1325 can include, for example, cameras (e.g., an analog camera, a digital camera), optics (e.g., one or more lenses, sensor focus lens groups, or microscope objectives), imaging sensors (e.g., a charge-coupled device (CCD), a complimentary metal-oxide semiconductor (CMOS) image sensor), photographic film, or the like. In digital embodiments, the image capture 1325 can include a plurality of lenses that cooperate to prove on-the-fly focusing. A CCD sensor can capture a digital image of the specimen.

One method of producing a digital image includes determining a scan area including a region of the microscope slide that includes at least a portion of a specimen to be imaged. For example, the specimen to be imaged can include a cell population. The scan area may be divided into a plurality of “snapshots.” An image can be produced by combining the individual “snapshots.” In particular embodiments, the image-capture device 1325 produces a high-resolution image of the entire specimen. Image capture device(s) 1325 can provide digital data of the images via peripheral system 1320 to processor 1386.

The user interface system 1330 can convey information in either direction, or in both directions, between a user 1338, e.g., a pathologist, clinician, technician, researcher, or other user, and the processor 1386 or other components of system 1301. The user interface system 1330 can include a mouse, a keyboard, another computer (connected, e.g., via a network or a null-modem cable), or any device or combination of devices from which data is input to the processor 1386. The user interface system 1330 also can include a display device, a processor-accessible memory, or any device or combination of devices to which data is output by the processor 1386. The user interface system 1330 and the data storage system 1340 can share a processor-accessible memory.

In various aspects, processor 1386 includes or is connected to communication interface 1315 that is coupled via network link 1316 (shown in phantom) to network 1350. For example, communication interface 1315 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WI-FI or GSM. Communication interface 1315 sends and receives electrical, electromagnetic, or optical signals that carry digital or analog data streams representing various types of information across network link 1316 to network 1350. Network link 1316 can be connected to network 1350 via a switch, gateway, hub, router, or other networking device.

In various aspects, system 1301 can communicate, e.g., via network 1350, with a data processing system 1302, which can include the same types of components as system 1301 but is not required to be identical thereto. Systems 1301, 1302 are communicatively connected via the network 1350. Each system 1301, 1302 executes computer program instructions to process images, e.g., as discussed herein with reference to FIG. 1 or Examples 1, 2, or 3. Additionally or alternatively, system 1301 can capture images and system 1302 can process the images, or vice versa.

Processor 1386 can send messages and receive data, including program code, through network 1350, network link 1316, and communication interface 1315. For example, a server can store requested code for an application program (e.g., a JAVA applet) on a tangible non-volatile computer-readable storage medium to which it is connected. The server can retrieve the code from the medium and transmit it through network 1350 to communication interface 1315. The received code can be executed by processor 1386 as it is received, or stored in data storage system 1340 for later execution.

Data storage system 1340 can include or be communicatively connected with one or more processor-accessible memories configured or otherwise adapted to store information. The memories can be, e.g., within a chassis or as parts of a distributed system. The phrase “processor-accessible memory” is intended to include any data storage device to or from which processor 1386 can transfer data (using appropriate components of peripheral system 1320), whether volatile or nonvolatile; removable or fixed; electronic, magnetic, optical, chemical, mechanical, or otherwise. Example processor-accessible memories include: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1340 can be a tangible non-transitory computer-readable storage medium, i.e., a non-transitory device or article of manufacture that participates in storing instructions that can be provided to processor 1386 for execution.

In an example, data storage system 1340 includes code memory 1341, e.g., a RAM, and disk 1343, e.g., a tangible computer-readable rotational storage device or medium such as a hard drive. Computer program instructions are read into code memory 1341 from disk 1343. Processor 1386 then executes one or more sequences of the computer program instructions loaded into code memory 1341, as a result performing process steps described herein. In this way, processor 1386 carries out a computer implemented process. For example, steps of methods described herein, blocks of the flowchart illustrations or block diagrams herein, and combinations of those, can be implemented by computer program instructions. Code memory 1341 can also store data, or can store only code. In some examples, at least one of code memory 1341 or disk 1343 can be or include a computer-readable medium (CRM), e.g., a tangible non-transitory computer storage medium.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, computer storage media do not include communication media. That is, computer storage media do not include communications media consisting solely of a modulated data signal, a carrier wave, or a propagated signal, per se.

The program code includes computer program instructions that can be loaded into processor 1386 (and possibly also other processors), and that, when loaded into processor 1386, cause functions, acts, or operational steps of various aspects herein to be performed by processor 1386 (or other processor). Computer program code for carrying out operations for various aspects described herein may be written in any combination of one or more programming language(s), and can be loaded from disk 1343 into code memory 1341 for execution. The program code may execute, e.g., entirely on processor 1386, partly on processor 1386 and partly on a remote computer connected to network 1350, or entirely on the remote computer.

In some examples, processor(s) 1386 and, if required, data storage system 1340 or portions thereof, are referred to for brevity herein as a “control unit.” For example, a control unit can include a CPU or DSP and a computer storage medium or other tangible, non-transitory computer-readable medium storing instructions executable by that CPU or DSP to cause that CPU or DSP to perform functions described herein. Additionally or alternatively, a control unit can include an ASIC, FPGA, or other logic device(s) wired (e.g., physically, or via blown fuses or logic-cell configuration data) to perform functions described herein.

In some examples, a “control unit” as described herein includes processor(s) 1386. A control unit can also include, if required, data storage system 1340 or portions thereof. For example, a control unit can include a CPU or DSP and a computer storage medium or other tangible, non-transitory computer-readable medium storing instructions executable by that CPU or DSP to cause that CPU or DSP to perform functions described herein. Additionally or alternatively, a control unit can include an ASIC, FPGA, or other logic device(s) wired (e.g., physically, or via blown fuses or logic-cell configuration data) to perform functions described herein. In some examples of control units including ASICs or other devices physically configured to perform operations described herein, a control unit does not include computer-readable media storing executable instructions.

### EXEMPLARY EMBODIMENTS

1. A system, including: an image-capture device configured to capture an image of a cell population, the image including input-pixel values of respective pixels of the image; and a control unit operatively connected with the image-capture device and configured to: determine a feature image based at least in part on the input-pixel values, the feature image including per-pixel feature values associated with respective pixels of the pixels of the image; determine a plurality of clusters based at least in part on the feature image, each cluster of the plurality of clusters associated with at least some of the pixels of the image; select a first cluster of the plurality of clusters, the first cluster associated with nuclei of cells in the cell population; determine a nuclei mask image representing pixels of the image associated with the first cluster; and determine a plurality of per-nucleus mask images by applying morphological operations to the nuclei mask image.
2. The system of embodiment 1, wherein the image-capture device and/or the control unit is configured to carry out one or more operations automatically.
3. The system of embodiment 1, wherein the image of the cell population is a histopathology image.
4. The system of embodiment 3, wherein the histopathology image is (a) an image of hemolysin and eosin (H&E) stained tissue section, or (b) an immunohistochemical (IHC) image including labeling of a biomarker in a tissue section. Optionally, the IHC image in some embodiments is one of a series of images from a single tissue section, each image reflecting the labeling of at least one different target within the tissue.
5. The system of embodiment 1, wherein the image-capture device further is configured to: (A) determine a response of a Gabor filter based at least in part on a first input-pixel value of a first pixel of the pixels of the image; and at least one of the per-pixel feature values associated with the first pixel is the response of the Gabor filter; and/or (B) determine a response of a Haralick filter based at least in part on a first input-pixel value of a first pixel of the pixels of the image; and at least one of the per-pixel feature values associated with the first pixel is the response of the Haralick filter; and/or (C) determine the plurality of clusters by performing k means clustering of at least some of the super-pixels based at least in part on the per-pixel feature values; and each of the super-pixels is associated by the k means clustering with exactly one cluster of the plurality of clusters; and/or (D) determine respective cytological profiles for a plurality of nuclei represented in the image, each nucleus associated with a respective one of the per-nucleus mask images; and determine a plurality of nucleus clusters based on the cytological profiles using Landmark-based Spectral Clustering (LSC), wherein each of the plurality of nuclei is associated with one of the plurality of nucleus clusters.
6. The system of embodiment 5(D), wherein the image-capture device further is configured to: (1) determine the plurality of nucleus clusters by: selecting a subset of the cytological profiles, the subset including fewer than all of the cytological profiles; determining a basis based on the subset of the cytological profiles; determining reduced cytological profiles for respective cytological profiles based on the basis; and clustering the reduced cytological profiles to provide the plurality of nucleus clusters; and/or (2) determine a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity; and/or (3) segment nuclei automatically by: mapping pixels of the image to a point on an n-dimensional feature space; determining super-pixels including data on one or more chosen features, each super-pixel associated with at least one pixel; and clustering neighboring pixels with similar features.
7. The system of embodiment 1, wherein the morphological operations include one or more of erosion, dilation, filtering, filling regions, filling holes, maxima/minima transform(s), maxima/minima determination, or watershed transformation.
8. The system of embodiment 1, wherein the control unit is configured to segment nuclei automatically by: mapping pixels of the histopathology image to a point on an n-dimensional feature space; determining super-pixels including data on one or more chosen features, each super-pixel associated with at least one pixel; and clustering neighboring pixels with similar features.
9. The system of embodiment 8, wherein at least one super-pixel includes at least one of: an R, G, B, Panchromatic (broadband), C, M, Y, Cb, Cr, CIE L*, CIE a*, CIE b*, or other data value of or determined based on a corresponding pixel; a Gabor filter response associated with a corresponding pixel; a Haralick feature value associated with a corresponding pixel; or another feature value associated with a corresponding pixel.
10. A computer-implemented method, including: capturing an image of a cell population, the image including input-pixel values of respective pixels of the image; determining a feature image based at least in part on the input-pixel values, the feature image including super-pixels associated with respective pixels of the pixels of the image, wherein each super-pixel includes one or more per-pixel feature value(s) associated with the respective pixel of the pixels of the image; determining a plurality of clusters based at least in part on the feature image, wherein each cluster of the plurality of clusters is associated with at least some of the pixels of the image; selecting a first cluster of the plurality of clusters, the first cluster associated with nuclei of cells in the cell population; determining a nuclei mask image representing pixels of the image associated with the first cluster; and determining a plurality of per-nucleus mask images by applying one or more morphological operations to the nuclei mask image.
11. The method of embodiment 10, wherein the method further includes: (A) determining a response of a Gabor filter based at least in part on a first input-pixel value of a first pixel of the pixels of the image; and at least one of the per-pixel feature values associated with the first pixel is the response of the Gabor filter; and/or (B) determining a response of a Haralick filter based at least in part on a first input-pixel value of a first pixel of the pixels of the image; and at least one of the per-pixel feature values associated with the first pixel is the response of the Haralick filter; and/or (C) determining the plurality of clusters by performing k means clustering of at least some of the super-pixels based at least in part on the per-pixel feature values; and each of the super-pixels is associated by the k means clustering with exactly one cluster of the plurality of clusters; and/or (D) determining respective cytological profiles for a plurality of nuclei represented in the image, each nucleus associated with a respective one of the per-nucleus mask images; and determining a plurality of nucleus clusters based on the cytological profiles using Landmark-based Spectral Clustering (LSC), wherein each of the plurality of nuclei is associated with one of the plurality of nucleus clusters.
12. The method of embodiment 11(D), further including: (1) determining the plurality of nucleus clusters by: selecting a subset of the cytological profiles, the subset including fewer than all of the cytological profiles; determining a basis based on the subset of the cytological profiles; determining reduced cytological profiles for respective cytological profiles based on the basis; and clustering the reduced cytological profiles to provide the plurality of nucleus clusters; and/or (2) determining a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity; and/or (3) segmenting nuclei automatically by: mapping pixels of the image to a point on an n-dimensional feature space; determining super-pixels including data on one or more chosen features, each super-pixel associated with at least one pixel; and clustering neighboring pixels with similar features.
13. The method of embodiment 10, wherein the image of a cell population is (a) an image of hemolysin and eosin (H&E) stained tissue section, or (b) an immunohistochemical (IHC) image including labeling of a biomarker in a tissue section. Optionally, the IHC image in some embodiments is one of a series of images from a single tissue section, each image reflecting the labeling of at least one different target within the tissue.
14. The method of embodiment 10, wherein the morphological operations include one or more of erosion, dilation, filtering, filling regions, filling holes, maxima/minima transform(s), maxima/minima determination, or watershed transformation.
15. The method of embodiment 10, which is a method of: grading cancer in a subject from which the cell population originated; diagnosing of cancer in a subject from which the cell population originated; or estimating tumor purity or determining a tumor purity score for the cell population.
16. A computer-readable medium, having thereon computer-executable instructions, the computer-executable instructions upon execution configuring a computer to perform operations including: capturing an image of a cell population, the image including input-pixel values of respective pixels of the image; determining a feature image based at least in part on the input-pixel values, the feature image including super-pixels associated with respective pixels of the pixels of the image, wherein each super-pixel includes one or more per-pixel feature value(s) associated with the respective pixel of the pixels of the image; determining a plurality of clusters based at least in part on the feature image, wherein each cluster of the plurality of clusters is associated with at least some of the pixels of the image; selecting a first cluster of the plurality of clusters, the first cluster associated with nuclei of cells in the cell population; determining a nuclei mask image representing pixels of the image associated with the first cluster; and determining a plurality of per-nucleus mask images by applying one or more morphological operations to the nuclei mask image.
17. The computer-readable medium of embodiment 16, further including instructions that, upon execution, configure the computer to perform operations including: (A) determining a response of a Gabor filter based at least in part on a first input-pixel value of a first pixel of the pixels of the image; and at least one of the per-pixel feature values associated with the first pixel is the response of the Gabor filter; and/or (B) determining a response of a Haralick filter based at least in part on a first input-pixel value of a first pixel of the pixels of the image; and at least one of the per-pixel feature values associated with the first pixel is the response of the Haralick filter; and/or (C) determining the plurality of clusters by performing k means clustering of at least some of the super-pixels based at least in part on the per-pixel feature values; and each of the super-pixels is associated by the k means clustering with exactly one cluster of the plurality of clusters; and/or (D) determining respective cytological profiles for a plurality of nuclei represented in the image, each nucleus associated with a respective one of the per-nucleus mask images; and determining a plurality of nucleus clusters based on the cytological profiles using Landmark-based Spectral Clustering (LSC), wherein each of the plurality of nuclei is associated with one of the plurality of nucleus clusters.
18. The computer-readable medium of embodiment 16(D), further including instructions that, upon execution, configure the computer to perform operations including: (1) determining the plurality of nucleus clusters by: selecting a subset of the cytological profiles, the subset including fewer than all of the cytological profiles; determining a basis based on the subset of the cytological profiles; determining reduced cytological profiles for respective cytological profiles based on the basis; and clustering the reduced cytological profiles to provide the plurality of nucleus clusters; and/or (2) determining a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity; and/or (3) segmenting nuclei automatically by: mapping pixels of the image to a point on an n-dimensional feature space; determining super-pixels including data on one or more chosen features, each super-pixel associated with at least one pixel; and clustering neighboring pixels with similar features.
19. The computer-readable medium of embodiment 16, wherein the morphological operations include one or more of erosion, dilation, filtering, filling regions, filling holes, maxima/minima transform(s), maxima/minima determination, or watershed transformation
20. The computer-readable medium of embodiment 16, which configures the computer to segment nuclei automatically by: mapping pixels of the histopathology image to a point on an n-dimensional feature space; determining super-pixels including data on one or more chosen features, each super-pixel associated with at least one pixel; and clustering neighboring pixels with similar features; wherein at least one super-pixel includes at least one of: an R, G, B, Panchromatic (broadband), C, M, Y, Cb, Cr, CIE L*, CIE a*, CIE b*, or other data value of or determined based on a corresponding pixel; a Gabor filter response associated with a corresponding pixel; a Haralick feature value associated with a corresponding pixel; or another feature value associated with a corresponding pixel.

The following examples are provided to illustrate certain particular features and/or embodiments. These examples should not be construed to limit the disclosure to the particular features or embodiments described.

### Example 1. Quantitative Analysis of Histological Tissue Image Based on Cytological Profiles and Spatial Statistics

This examples provides an effective methodology for quantitative analysis for biological images such as H&E stained or IHC labeled tissue sections. At least some of the material presented in this example was published as Chang et al., Conf Proc IEEE Eng Med Biol Soc. Aug. 16-20, 2016; published online October 2016:1175-1178. doi: 10.1109/EMBC.2016.7590914.

FIG. 1 shows an example dataflow diagram. Data items are represented using dashed outlines merely to distinguish them from operations. An input image, e.g., of an IHC-labeled or H&E-stained tissue sample, is captured by image capture device 1325 or otherwise received by processor 1386. The input image includes input pixels, e.g., numbering nₓ×n_{y} in a two-dimensional image. Input pixels can have input-pixel values, e.g., RGB, YCbCr, or other values. In some examples, each and every one of the input pixels in the image can be used in determining a feature image, as discussed below. In other examples, fewer than all of the input pixels can be used in determining a feature image.

Features are extracted as described herein, e.g., Haralick, Gabor, or other features (“Feature Extraction”). For brevity, a “per-pixel feature” refers to an image feature that is determined based on pixels(s) of an input image and that has value(s) associated with specific one(s) of the pixel(s) of the input image. For example, the input image can be convolved with a filter to provide a filtered image, and the pixels of the filtered image can be per-pixel features. In some examples, each pixel of the filtered image (an example of a “feature image”) is a feature value for the respective image pixel. Additionally or alternatively, a patch (a portion of the input image) around each input pixel can be processed to determine per-pixel feature values for that input pixel.

Per-pixel feature values can then be assembled together with RGB or other input-pixel values to provide super-pixels. The super-pixels can be assembled into a “feature image.”

Unsupervised clustering of the super-pixels of the feature image can then be performed, e.g., based on the per-pixel feature values, to determine which cluster each pixel belongs to. This provides nuclei segmentation, e.g., distinguishing nuclei in the image from each other. The results of nuclei segmentation can be used as input to cytological clustering operations, described below.

Nuclei Segmentation:

The H&E staining method colors cells nuclei blue by hematoxylin, and the nuclei staining is followed by counter-staining with eosin, which colors other structures in various shades of red and pink (Wang, PLoS ONE, 6(2), 2011). Thus, each pixel has intensity (e.g., in each of several channels, such as R, G, and B channels) and represents a part of morphological features. In order to segment nuclei, useful morphological features can be extracted from the image and then individual pixels can be clustered based on their features. To do so, a set of wavelets, e.g., Gabor filters with different frequencies and orientations, or other wavelets, can be used. Example Gabor filters are described in Mehrotra et al. (Pattern Recognition, 25: 1479-1494, 1992). These are useful for texture representation and discrimination, i.e., edge detection in image processing. For each pixel, various features such as intensities and the impulse responses of one or more Gabor filters having respective frequencies and orientations can be collected to form a respective super-pixel, e.g., a respective feature vector for that pixel. The types of feature(s) can be chosen by users, in some examples. Each feature vector can have n elements and can correspond with a point in an n-dimensional feature space of the super-pixels. In some examples, e.g., as shown in FIG. 2, the n elements can include R, G, and B pixel intensities, and other non-intensity features.

Similarly to analysis of H&E stained tissue sections, IHC labeling provides tissue sections that are “colored” with different labeled antibody molecules; analysis of such colored samples can be carried out as with H&E stained samples.

Once each image pixel is mapped to a point in an n-dimensional feature space as shown in FIG. 2 (left), neighboring super-pixels which have similar features are clustered (e.g., using k-means clustering or other clustering techniques). This can permit differentiating between foreground and background, or between different tissues, cells, or nuclei. In some examples, nuclei segmentation is effectively performed by partitioning groups in the feature space. In some examples, unusual segmented parts can be excluded based on cytological profiles described further below. In some examples, k-means clustering is used with k=4. In some examples, different k values can be tested, and the highest value that does not exhibit sub-divided groups can be selected for further processing.

As shown in FIG. 1, in some examples, the unsupervised clustering operation can provide data (depicted as ovals) of one or more clusters representing different types of nuclei, cells, or other items. Each cluster can include, e.g., data of an outline of the item in the image (e.g., coordinates of line segments), data of the interior of the item in the image (e.g., pixels set to a first value within the item and to a second, different value outside the item), or other data indicating which portion of the input image is associated with that type of item. In the example of FIG. 1, at least a nuclei cluster can be provided. Other cluster(s) can additionally or alternatively be provided, e.g., a background (non-nucleus or non-cell) cluster, a stromal-cell cluster, or an “other” cluster representing imaging artifacts or other areas that cannot be clustered into one of the more definite clusters. In some examples, the clusters provided by the unsupervised clustering process are not identified as “background,” “nuclei,” etc.

In some examples, an automated mask assignment operation can provide an overall nuclei mask, or one mask per nucleus, based on the cluster(s) resulting from unsupervised clustering. In some examples, after clustering groups of super-pixels based on each super-pixel's features, the intensity values of the corresponding pixels can be used to assign pixels to the nuclei group. For example, in an H&E-stained sample, pixels in nuclei, stained blue, will have much higher blue components (B) (and may therefore have much lower Y values) than pixels in non-nuclei, stained red or pink. Therefore, the cluster of super-pixels corresponding to the highest average or peak B values can be selected as the nuclei cluster. An output mask, e.g., an image with pixel values of 1 (or another non-null value) for nuclei and 0 (or a null value) for non-nuclei, or 1 (or non-null) for the outlines of nuclei and 0 (or null) for other pixels, can be provided by rendering the shape information from the cluster into an nx×ny image. Accordingly, the result of unsupervised clustering can be a division of the image into regions for background, stroma, nuclei, or other cellular or extracellular components.

In some examples, mathematical morphology operations can be used to separate touching nuclei, clean nucleus boundaries, etc. The morphology operations can be applied to cluster data or to mask data, e.g., to the nuclei mask representing the nuclei region. Morphological operations can include, e.g., erosion, dilation, filtering, filling regions or holes, maxima/minima transforms or determination, watershed transformation, or other operations on images. In some examples, the morphology operations can include separating data corresponding to different nuclei and generating per-nuclei output mask(s). For example, the watershed transform can be used to separate regions of an image corresponding to different nuclei, by applying the transform to an image representing distances from the edge of a nucleus.

In some examples, the following morphological operations can be used. The operations specified in the numbered list below can be used in the order in which they are listed. Additionally or alternatively, at least some of the operations in the list can be used in an order different from that in which they are listed. Additionally or alternatively, fewer than all of the operations in the list can be used. In some examples, the inputs to the morphological process are the input image and the nuclei mask (binary image) from the clustering. In some examples, the outputs of the morphological process can include labels and images, including watershed identifiers (e.g., numbers 1, 2, . . . ). In the watershed results, the watershed basins represent the nuclei, and the watershed edges represent the contours between the nuclei.
1. Determine a grayscale image based on the input image, e.g., by determining the Y component of the input image according to ITU-R Rec. 709 (or another luma/chroma color-space).
2. Perform a Sobel gradient filtering on the output of #1. This provides a gradient image. Additionally or alternatively, a different gradient than Sobel can be used, e.g., a Prewitt, cross, morphological, or other gradient.
3. Erode the nuclei mask image that was provided as input to the algorithm, as noted above.
4. Perform geodesic reconstruction of the output of #3, using the nuclei mask image as a reference/constraint. This can permit providing a cleaner image having fewer small artifacts.
5. Perform a median-filtering operation on the input image (in, e.g., an RGB color space).
6. Determine a CIE 709 (or other color-space) gray (e.g., Y) level image of the output of #5, then perform gray level pixel inversion of that image (e.g., x←255-x).
7. Perform an alternating sequential filtering on the output of #6, starting with opening, using a hexagonal structuring element. This can reduce noise.
8. Perform a pixel-by-pixel AND operation between the nuclei mask image and the output of #7. The AND operation produces zero wherever the nuclei mask image has a zero (non-nucleus) value, and copies the corresponding pixels from the output of #7 wherever the nuclei mask image has a non null (nucleus) value.
9. Determine local maxima of the output of #8. These maxima can be used, e.g., as inner markers for a watershed transform.
10. Perform outer contour extraction on the nuclei mask image. This can provide outer markers for the watershed transform.
11. Perform a watershed transform on the output of #2 using the markers output by #9 and #10.
12. Perform connected-component labeling on the output of #11, and merge small patterns (“small” being defined by a predetermined size).
13. Update basins and contours in the watershed output of #11 for the merged components.

Following production of the watershed results, the watershed basins (e.g., from #13 above) can be divided into per-nuclei mask images. For example, given a watershed image in which each pixel has a value of either zero (not part of a watershed) or exactly one of n distinct watershed identifiers, e.g., 1, 2, . . . , n, n per-nucleus images can be provided. In some examples, one or more of the watershed identifiers can correspond to non-nuclei. In per-nucleus image i, i∈(1,n), the pixels can have the value 1 (or another “nucleus” value, e.g., a non-null value) where the corresponding pixels of the watershed image have value i, and the value 0 (or another “non-nucleus” value, e.g., a null value) elsewhere.

Cytological Profiling and Clustering.

Once individual nuclei in the stained (e.g., H&E or IHC stained) section have been segmented based on the pixel-level clustering and output-mask processing described above, cytological profiles for individual nuclei can be extracted. This cytological profile for a particular nucleus includes a set of numbers that describe the spatial characteristics of that cell, including, e.g., size, shape, or the intensities and textures of various stains, and thus it can be used for classifying cellular types. For example, in FIG. 2 (right), different nuclei classes (“cell regions” in FIG. 2) show various textural and morphological characteristics. To obtain morphological characteristics of a nucleus, various features can be measured based on the respective per-nucleus mask image, or on those pixels of the input image indicated by the per-nucleus mask as representing that nucleus. Example features can include area, major/minor axis length, perimeter, equivalent diameter, shape indices (eccentricity, Euler number, extent, solidity, compactness, circularity, aspect ratio, etc.), intensity, centroid or other location information, bounding box size/orientation/coordinates, or bounding ellipse size/orientation/coordinates. For example, location can be used for spatial pattern analysis. Features can be determined, e.g., using techniques described in Jones et al. (PNAS, 106(6): 1826-1831, 2009). Combining these features derives high-dimensional feature vectors to describe the characteristics of respective, individual nuclei. The result can be at least one output mask, each output mask corresponding to a respective nucleus, as shown in FIG. 1.

In some examples, techniques described herein with respect to nuclei can additionally or alternatively be used to locate other types of structures depicted in the input image. In some examples, to determine masks for whole cells, a marker is applied to the cells to stain the cytoplasm before capturing the input image. Stained cells (cytoplasm regions) can then be distinguished as described herein with reference to stained nuclei. In some examples, to determine masks for whole cells, nuclei are located as described above. The cytoplasm associated with each nucleus is then approximated using a predetermined rule, e.g., as a respective annular region around each detected nucleus, using the watershed transform, or using the Propagate algorithm of Jones. In some examples, masks can be determined for any targets of interest using an image captured after staining those targets using an appropriate stain.

Particular embodiments can utilize Landmark-based Spectral Clustering (LSC) to perform cytological profiling and clustering. For example, once features such as those noted above are extracted for the individual nuclei (or other targets of interest, e.g., cells, as noted above, and likewise throughout the remainder of the discussion of FIG. 1), LSC (Cai and Chen, Cybernetics, IEEE Transactions, 45: 1669-1680, 2015) can be used for large scale clustering. Let X=(x1, . . . , xN)∈R^{m×N} be a data matrix, where xi represents a feature vector corresponding to the i-th nucleus, m represents the dimensionality of a feature vector xi, and N is the number of segmented nuclei. By using sparse coding (Nayak et al., Biomedical Imaging (ISBI), 2013 IEEE 10th International Symposium on, 410-413, 2013), one can find two matrices: a set of basis vectors U∈R^{m×P} and the sparse representation with respect to the basis for each data point Z∈R^{p×N} whose product can best approximate X≈UZ. Histological images may include tens of thousands or hundreds of thousands of nuclei, so N may be very large. In some examples, Landmark-based Spectral Clustering (LSC) is used. LSC (Cai & Chen, Cybernetics, IEEE Transactions, 45: 1669-1680, August 2015) selects p representative data points in the m-dimensional feature space as “landmarks,” e.g., to be used as basis vectors. The representative data points can be selected, e.g., randomly, or using k-means, k-medoids, or another clustering technique. The number p of landmarks can be determined empirically, e.g., by testing the performance of classifications determined using various values of p. Any individual landmark can be a point in the data set, or can be a point in the m-dimensional feature space that is not in the data set.

Once the landmarks are selected, the original data points can be represented as the linear combinations of these landmarks. A spectral embedding of the dataset can then be efficiently computed with the landmark-based representation. In an example of forming k clusters, the spectral embedding can include, for each original data point, the k-dimensional representation in the basis formed by the eigenvectors of an affinity matrix that correspond to the k smallest eigenvalues of that affinity matrix. The number of eigenvectors used in the basis can alternatively be greater or less than the number of clusters. Then, k-dimensional feature vectors representing the individual segmented nuclei can be clustered into different types, e.g., using k-means or another clustering technique. This can permit clustering based on the characteristics of the nuclei with reduced computational burden compared to clustering in the m-dimensional space, m>k.

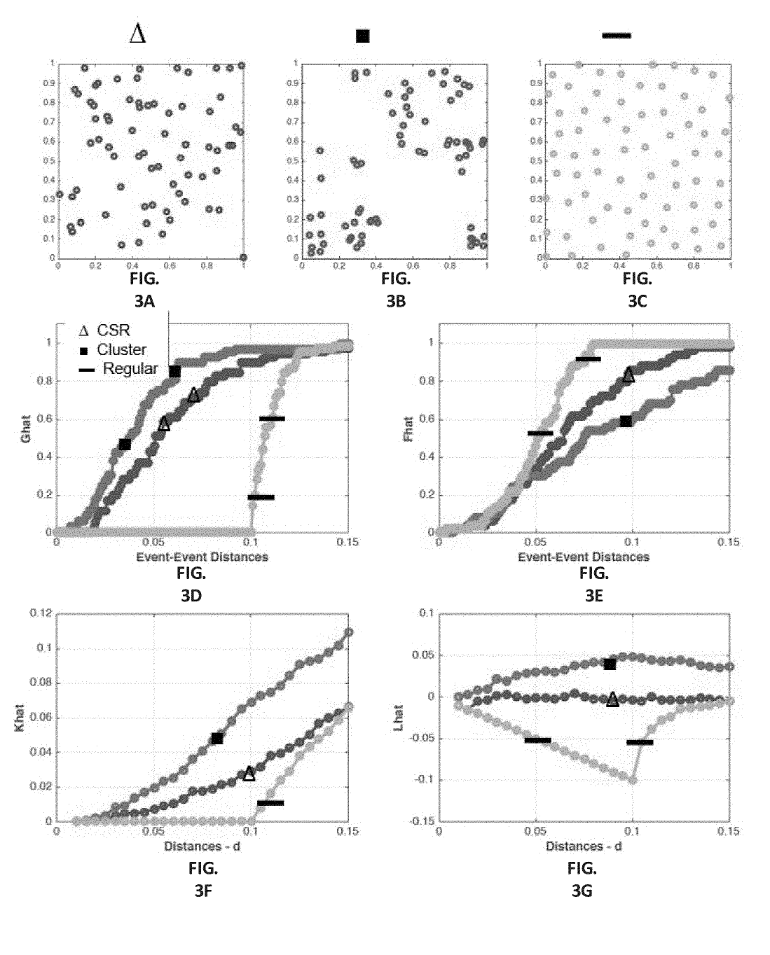

FIG. 3 shows an example of Spatial Statistics (Martinez & Martinez, Computational Statistics Handbook with MATLAB, Second Edition. Chapman and Hall/CRC, 2 ed., 2007). In some examples discussed above with reference to FIGS. 1 and 2, only individual (e.g., per-nucleus) cytoprofiles were used for clustering data points into clusters representing different cellular types. Since spatial arrangement and architectural organization of nuclei is generally not reflected in cellular profiles, this rich information is underused. In addition, biological heterogeneities (e.g., cell type), technical variations (e.g., staining, fixation) and high redundancy in the feature representations can degrade the performance of a classifier (Zhou et al., Computer Vision and Pattern Recognition (CVPR), 2014 IEEE Conference, 3081-3088, 2014). To address this issue, spatial statistics analysis can be used with cellular characteristics analysis. Spatial statistics analysis can permit characterizing spatial distributions across different cell types such as normal, tumor cells, or lymphocytes.

Spatial statistics or spatial analysis is concerned with statistical methods that explicitly consider the spatial arrangement of the data (Martinez and Martinez, Computational Statistics Handbook with MATLAB, Second Edition. Chapman and Hall/CRC, 2 ed., 2007). The observations might be spatially correlated (e.g., in two dimensions in FIGS. 3A-3C), which should be accounted for in the analysis. A spatial point pattern (S) is a set of point locations in a study region R and the term event can refer to any spatial phenomenon that occurs at a point location. The benchmark model for spatial point patterns is called complete spatial randomness (CSR). Under CSR, events are distributed independently and uniformly over the study region as shown in FIG. 3A.

The behavior of spatial patterns is examined in terms of two properties: first-order properties measure the distribution of events in a study region (spatial density) and second-order properties measure the tendency of events to appear clustered, independently, or regularly-space (interaction between events). Second-order properties were investigated by studying the distances between events in the study region.

Nearest neighbor distances—G and F distributions: The G-function measures the distribution of distance from an arbitrary event to its nearest neighbors (nearest event):

$$\hat{G} ( w ) = \frac{{\sum }_{i = 1}^{n} {I}_{i}}{n} , where {I}_{i} = \{ \begin{matrix}1 & if {d}_{i} ∈ \{ {d}_{i} \text{:} {d}_{i} \leq w , ∀ i \} \\ 0 & otherwise\end{matrix}$$

where di=minj{dij, ∀j I=i∈S}, i=1, . . . , n. Under CSR, the value of the G-function becomes G(w)=1−e^{λπw} where λ is the mean number of events per unit (intensity). The comparability of a point process with CSR can be assessed by plotting the empirical function G^{∧}(w) against the theoretical expectation G(w) as shown in FIG. 3D. For instance, for a clustered pattern, observed locations should be closer to each other than expected CSR and thus it would be expected that G^{∧}(w) would climb steeply for smaller values of w and flatten out as the distances get larger.

The F-function measures the distribution of all distance from an arbitrary point k in the plane to the nearest observed event j:

$$\hat{F} ( x ) = \frac{{\sum }_{k = 1}^{m} {I}_{k}}{m} , where {I}_{k} = \{ \begin{matrix}1 & if {d}_{k} ∈ \{ {d}_{k} \text{:} {d}_{k} \leq x , ∀ k \} \\ 0 & otherwise\end{matrix}$$

where dk=minj{dkj, ∀j∈S}, k=1, . . . , m, j=1, . . . , n. Under CSR, the expected value is also F (x)=1−e^{λπx}. When a plot of F^{∧}(x) (FIG. 3E) is examined, the opposite interpretation holds. For example, for a clustered pattern, observed locations j should be farther away from random points k than expected under CSR.

2) K, L distributions: A homogeneous set of points in a study region R is distributed such that approximately the same number of points occurs in any circular region of a given area. A set of points that lacks homogeneity is spatially clustered. A simple probability model for spatially homogeneous points is the Poisson process in R with constant intensity function. Then, the K-function is defined as K^{∧}(d)=λ⁻¹E(#extra events within distance d of an arbitrary event) where λ is a constant representing the intensity over the region and E(⋅) denotes the expected value. For a CSR spatial point process, the theoretical K-function is K(d)=πd².

FIG. 3F shows the function K^{∧}(d) for the data. Note that it is above the curve for a random process (e.g., K^{∧}(d)>πd²) indicating possible clustering. Alternatively, if the observed process exhibits regularity for a given value of d, then that the estimated K-function will be less than πd² is expected.

Another approach, based on the K-function, is to transform K^{∧}(d) using

$$\hat{L} ( d ) = \sqrt{\frac{\hat{K} ( d )}{π}} - d .$$

Peaks of positive values in a plot of L^{∧}(d) would correspond to clustering and negative values indicating regularity, for the corresponding scale d. In the plot of L^{∧}(d) (FIG. 3G), possible evidence of clustering at all scales is seen.

Experiments and Results.

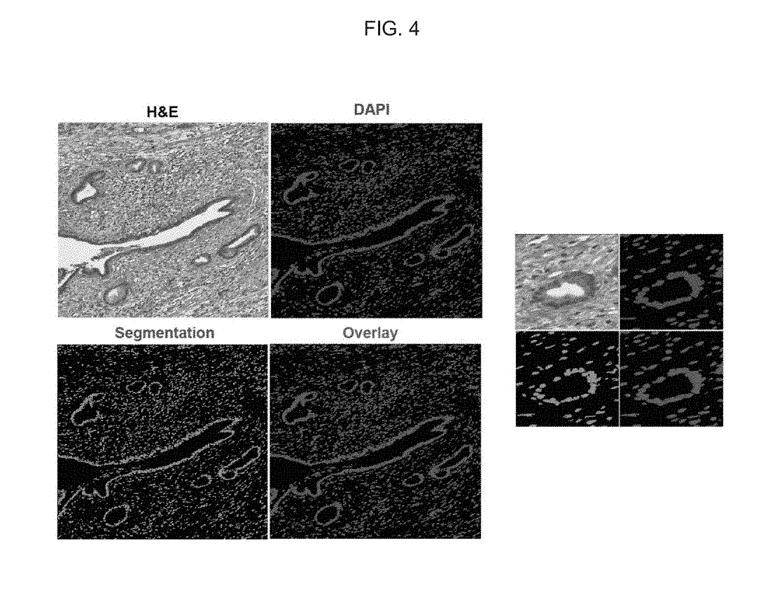

In order to quantitatively evaluate the segmentation provided by the disclosed methods, the segmentation results were compared to DAPI as the ground truth immunofluorescence marker. FIG. 4 reports the validation of segmentation result. True positive rate (sensitivity)=0.8070, true negative rate (specificity)=0.9437, accuracy rate=0.9249 among 7924 nuclei were calculated based on pixel level. Also, the Dice coefficient is 0.7474. The Dice coefficient is a measure of overlap between two regions, commonly used for evaluation of segmentation techniques,

$$D ( X , \breve{Y} ) = 2 \frac{\vert X ⋂ Y \vert}{\vert X \vert + \vert Y \vert} .$$

Quantitative Analysis Based on Cellular Characteristics and Spatial Statistics.

Once individual nuclei were segmented, cellular characteristics were extracted from the tumor cell/normal cell/lymphocyte regions as shown in FIG. 2 (right). In order to characterize different classes of nuclei (among 5431 nuclei), 6 clusters were chosen and LSC was run. In a tested example, k-means clustering was performed using various values of k. The value k=6 was chosen using silhouette analysis. Silhouette analysis permits evaluating the explanatory power of a particular k value based on how close each point in a cluster is to points in the other clusters. Silhouette values range from −1 to +1 for each cluster, and values far from +1 can indicate that a different value of k should be used.

FIG. 5 shows a population (covered area ratio) of segmented nuclei subjected to a particular cluster in each H&E section respectively. For example, it was observed that nuclei corresponding to cluster 5 and cluster 4 are distinctively dominant in lymphocyte region and normal cell region respectively. However, one cannot perfectly discriminate different classes of nuclei based on cellular characteristics alone. For instance, although nuclei corresponding to cluster 3 are dominant in tumor region, they also exist in normal cell region. Thus, there is no unique cluster representing a specific cell type (i.e., tumor) in this tested example.

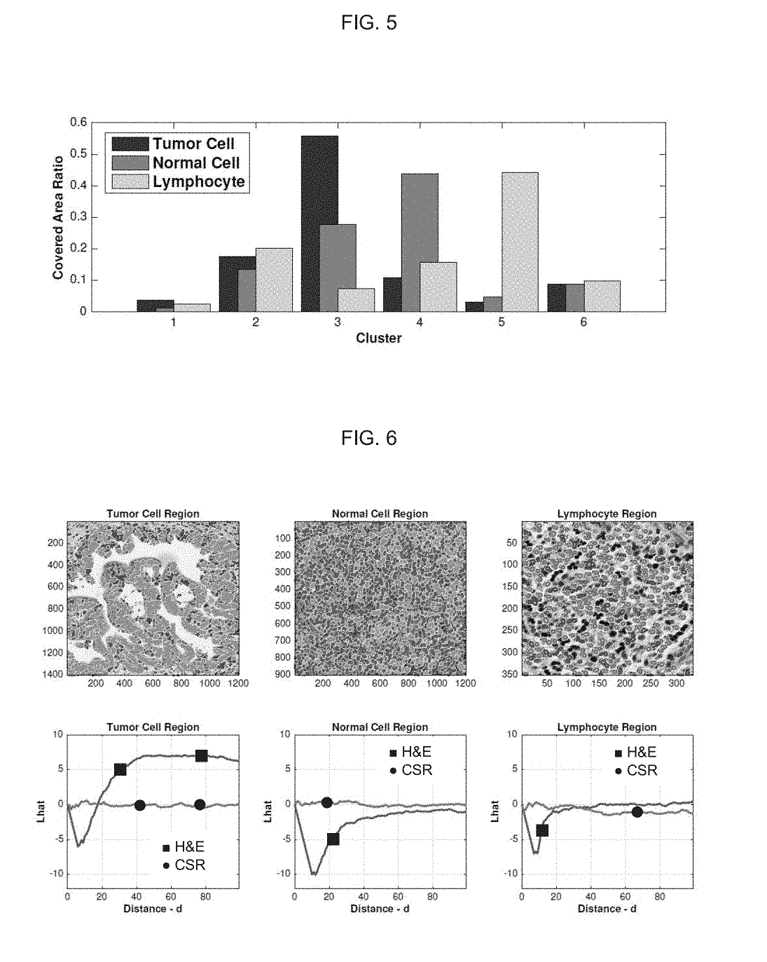

In order to complement cellular characteristics analysis, a spatial distribution of dominant nuclei type along the different regions (tumor/normal cell/lymphocyte) was characterized. It was observed that tumor cells are differentially distributed. FIG. 6 (top row) shows distribution of individual segmented nuclei which were color-coded according to their clusters (blue: cluster 2, green: cluster 3, red: cluster 4, magenta: cluster 5). FIG. 6 (bottom row) shows the second-order spatial statistics of selected nuclei. Here, the pattern was examined at several scales, i.e., using L^{∧}-function since in general, both G^{∧}(w) and F^{∧}(x) consider the spatial point pattern over the smallest scale. Using L^{∧} can permit more effectively analyzing clustered patterns where nearest-neighbor distances are very short relative to other distances in the pattern. For a tumor region, dominant types were chosen (e.g., cluster 2 and 3) and L^{∧}-distribution calculated. In keeping with the cluster behavior seen visually in FIG. 6, top left, there is strong evidence of clustering in the plot of L^{∧}(d), FIG. 6, bottom left. On the other hand, for both normal cell region and lymphocyte region, point patterns do not exhibit appreciable clustering behavior, as indicated by the bottom-center and bottom-right plots.

Example 1 demonstrates an effective methodology for quantitative analysis for biological images such as H&E (or IHC labeled) tissue sections. The techniques of Example 1 can additionally or alternatively be used to segment or analyze other images, e.g., to cluster features therein. Test were performed demonstrating the performance of the segmentation algorithm by comparing the result to ground truth data (DAPI fluorescent staining), and that spatial statistics analysis benefits H&E section analysis by complementing cellular characteristics analysis.

### Example 2

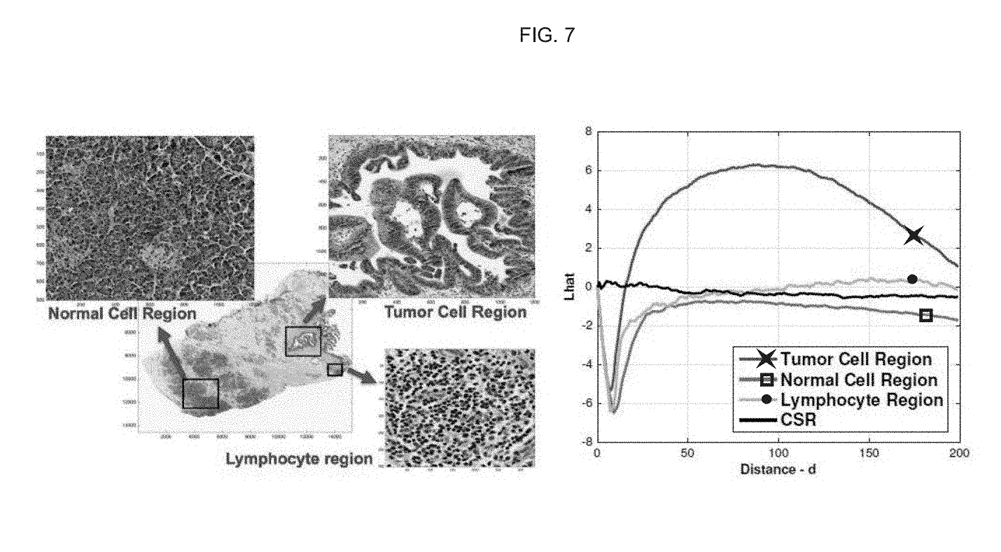

FIG. 7 shows an example of Integrative Analysis on Histopathological Image for Identifying Cellular Heterogeneity. Example 1 describes analyzing single point patterns against CSR using K-function analysis. In a tested example, a spatial distribution of dominant nuclei type along the different regions was characterized. It was observed that tumor nuclei are differentially distributed as shown in FIG. 7 (right) where three representative regions were selected (tumor cell, normal cell and lymphocyte region) from the whole slide section shown in FIG. 7 (left). Note that a stationary and spatially homogeneous point process within each region is assumed.

Analysis of Spatial Similarity.

Some examples analyze relationships between more than one pattern. When one compares two populations, some example analyze whether or not these events influence one another in some way, or how similar these spatial point patterns are. For example, in H&E sections where tumor cells are found, there will invariably be other cells such as lymphocytes competing with tumor cells. Various examples determine whether the pattern of tumor-like cells, S1, is more clustered than the pattern of lymphocytes, S2 in the study region R.

To do so, one may compare marginal distribution of two patterns by examining how the spatial point patterns S1 and S2 are similar (Smith, “Notebook on spatial data analysis.” Lecture Note (2016); available online at seas.upenn.edu/˜ese502/#notebook) instead of analyzing their joint distribution (i.e., cross K-functions to test whether there was significant “attraction” or “repulsion” between two patterns). If the sizes of 51 and S2 are given respectively by n1 and n2, then null hypothesis is simply that the combination of these two patterns is in fact a single population realization of size n (=n1+n2). If this was true, the sample K-functions, K^{∧}1(d) and K^{∧}2(d) should be estimating the same K-function. In this context, “complete similarity” would reduce the simple null hypothesis, H0: K1(d)=K2(d). However, this simplification is only appropriate for stationary isotropic processes with Ripley correction so “complete similarity” should be characterized in a way that will allow deviations from this hypothesis to be tested statistically (Smith, “Notebook on spatial data analysis.” Lecture Note (2016)). Even in the absence of stationarity, the sample K-functions continue to be reasonable measures of clustering (or dispersion) within populations. Hence, to test for relative clustering (or dispersion), it is natural to focus on the difference between these sample measure, i.e., Δ(d)=K^{∧}1(d)−K^{∧}2(d). Note that if both samples are indeed coming from the same population, then K^{∧}1(d) and K^{∧}2(d) should be estimating the same K-function (complete similarity). The relevant spatial similarity hypothesis for this analysis is that the observed difference is not statistically distinguishable from the random differences obtained from realizations of the conditional distribution of labels under the spatial indistinguishability hypothesis*. Smith, “Notebook on spatial data analysis.” Lecture Note (2016).

Then, various examples simulate random relabelings to obtain a sampling distribution of Δ(d) under this spatial similarity hypothesis. The observed difference is then compared with this distribution. Also, one can calculate p-values for various simulations and interpret the p-value output. For instance, if the observed difference is unusually large (small) relative to this distribution, then it can reasonably be inferred that S1 is significantly more clustered (dispersed) than S2; this procedure can be summarized by the following simple variation of the random relabeling test (Smith, “Notebook on spatial data analysis.” Lecture Note (2016)):
Step 1: given (s₁, . . . , sₙ) and (m₁, . . . , mₙ), simulate N random permutations and construct the corresponding the label permutations (m_{π}_{₁}₍ₖ₎, . . . , m_{π}_{ₙ}₍ₖ₎), k=1, . . . , N.
Step 2: given S₁^{k} and S₂^{k} obtained from [(s₁, . . . , sₙ), (m_{π}_{₁}₍ₖ₎, . . . , m_{π}_{ₙ}₍ₖ₎)], calculate the sample difference values Δ^{k}(d)=\hat{K}₁^{k}(d)−\hat{K}₂^{k}(d) for each k=1, . . . , N and set of relevant radial distances d. If S₁^{k} and S₂^{k} denote the population patterns obtained from the joint realization [(s₁, . . . , sₙ), (m_{π}_{₁}₍ₖ₎, . . . , m_{π}_{ₙ}₍ₖ₎)], for the given set of relevant radial distances, D={d_{w}: w=1, . . . , W}, calculate the sample difference values {Δ^{k} (d_{w}): w=1, . . . , W} for each k=1, . . . , N where Δ^{k} (d)=\hat{K}₁^{k}(d)−\hat{K}₂^{k}(d).
Step 3: under the spatial similarity hypothesis, from the list of Δ^{k} (d) obtained from Step 2, the probability of obtaining a value as large as Δ⁰(d) is estimated by the relative clustering p-value for S₁ versus

$${S}_{2} , {\hat{p}}_{clustered}^{12} ( d ) = \frac{{m}_{+}^{0} + 1}{N + 1}$$

where m₊⁰ denotes the number of simulated random relabelings with Δ^{k}(d)≥Δ⁰(d). Similarly, the probability of obtaining a value as small as Δ⁰(d) is estimated by the relative dispersion p-value for S₁ versus

$${S}_{2} , {\hat{p}}_{dispersed}^{12} ( d ) = \frac{{m}_{-}^{0} + 1}{N + 1}$$

where m₋⁰ denotes the number of simulated random relabeling with Δ^{k}(d)<Δ⁰(d).
Under the spatial similarity hypothesis, each observed value Δ⁰(d_{w}) should be a “typical” sample from the list of values [Δ^{k} (d_{w}): k=0, 1, . . . , N]. Hence if we now let m₊⁰ denote the number of simulated random relabelings with Δ^{k}(d_{w})≥Δ⁰(d_{w}), then the probability of obtaining a value as large as Δ⁰(d_{w}) under this hypothesis is estimated by the relative clustering p-value for population 1 versus population 2:

$${\hat{p}}_{clustered}^{12} ( d ) = \frac{{m}_{+}^{0} + 1}{N + 1} .$$

Similarly, if m₋⁰ denotes the number of simulated random relabeling with Δ^{k} (d_{w})≤Δ⁰(d_{w}), then the probability of obtaining a value as small as Δ⁰(d_{w}) under this hypothesis is estimated by the following relative dispersion p-value for population 1 versus population 2:

$${\hat{p}}_{dispersed}^{12} ( d ) = \frac{{m}_{-}^{0} + 1}{N + 1} .$$

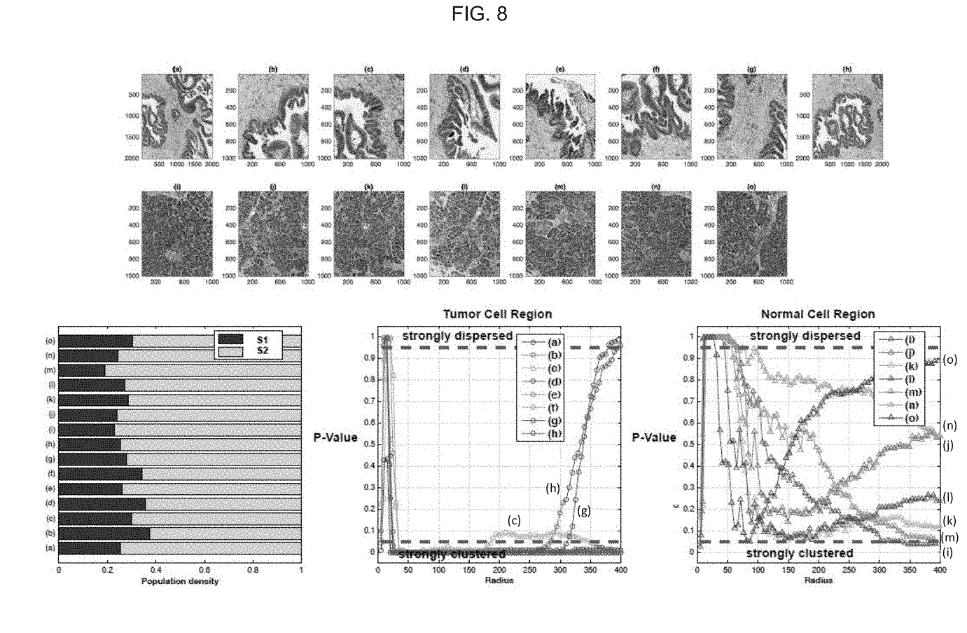

FIG. 8 shows example experimental results. Two patterns in the study region were compared. For example, since lymphocytes can be reliably differentiated from other nuclei types, S2 was considered as lymphocyte and S1 as other cells in the region. In some examples:

S1 and S₂ satisfy both spatial independence and exchangeability conditions as follows:

Pr[(m₁, . . . ,mₙ)|(s₁, . . . ,sₙ)]=Pr(m₁, . . . ,mₙ) (spatial independence):

Pr(m_{π}_{₁}, . . . ,m_{π}_{ₙ})=Pr(m₁, . . . ,mₙ) (exchangeability):

where mᵢ,sᵢ represents event label and location respectively, πᵢ represents random permutations and Pr[(m₁, . . . , mₙ)|(s₁, . . . , sₙ)] denotes the conditional distribution of event labels given their locations and Pr(m₁, . . . , mₙ) denotes marginal distribution of event labels.

Fifteen different regions were selected as shown in FIG. 8 (top, (a)-(h): tumor cell regions, (i)-(o): normal cell regions). In FIG. 8 (bottom left), population density of S1 (either tumor cell or normal cell) versus S2 (lymphocyte) in each region was plotted but there is no distinct difference of population density between tumor and normal cell region. However, if spatial similarity between S1 and S2 are compared, a distinct spatial pattern for those two regions is clearly observed. FIG. 8 (bottom middle, tumor region) shows that S1 is significantly more clustered than S2 where values below the red dashed line on the bottom (0.05) denotes the significant clustered pattern at the 95 percent confidence interval. On the other hand, in normal cell region (bottom right), that S1 is significantly more dispersed than S2 was inferred where values above the red dashed line at the top (0.95) denotes significant dispersion at the 95 percent confidence interval. Therefore, distinct spatial distribution of nuclei in two different regions, can be characterized for example, tumor cell nuclei are indeed more clustered than lymphocytes, but normal cell nuclei are more strongly dispersed within radius <100 pixels than lymphocytes. In other words, spatial distributions of lymphocyte are different between tumor cell region and normal cell region although there is no distinct difference in the population.

Example 2 provides effective techniques for an integrative analysis on images of H&E sections. This analysis can additionally or alternatively be performed with respect to other images. That spatial pattern analysis complements cellular characteristics analysis was demonstrated experimentally. Spatial distribution of lymphocytes in the study region was also characterized. It was found that lymphocyte infiltrations are different between tumor cell region and normal cell region.

### Example 3

Genomic sequencing is an established tool in basic research, and the advent of massively-parallel next-generation sequencing (NGS) has allowed the adoption of genomic sequencing as a clinical diagnostic tool. However, existing challenges in the analysis of NGS data serve to limit its clinical utility. One of these challenges is the infiltration of non-cancerous cells in tumors, which affects the interpretation and clinical utility of genomic analyses. For this reason, the estimation of tumor purity (TP) has been an important topic of many studies to compensate for the effect of non-cancerous cells (Aran et al., Nature Communications, 6, 2015; Oesper et al., Genome Biology, 14(7): 1, 2013; Yuan et al., Science Translational Medicine, 4(157): 157ra143-157ra143, 2012).

Currently, tumor purity scores are often derived from the visual estimation of tumor specimens by trained pathologists. However, it has been shown that there exist vast inter-observer discrepancies in the estimation of TP by pathologists (Smits et al., Modern Pathology, 27(2): 168-174, 2014), which may lead to incorrect indicators of prognosis and/or response to treatment in certain cancer types. For example, TP can indicate the presence of clonal populations of cancerous cells in a given tumor, a feature that may help predict prognosis and response to treatment (Sallman et al., Leukemia, 30(3): 666-673, 2016; Biswas et al., Scientific Reports, 5, 2015; Sallman & Padron, Hematology/Oncology and Stem Cell Therapy, 2016). Another confounding effect caused by differences in TP (Zhao et al., Cancer Research, 64(9): 3060-3071, 2004) across tumors is the detection of DNA copy number variations (CNV), a feature which has been shown to contribute to cancer pathogenesis (Juric et al., Nature, 518(7538): 240-244, 2015; Zack et al., Nature Genetics, 45(10): 1134-1140, 2013; Park et al., Molecular cancer, 14(1): 1, 2015). Thus, an accurate and consistent estimation of TP promises to be a useful measure, not only to enhance the utility of genomic sequencing data, but also for better clinical outcome.

Recently, many statistical algorithms have been developed in an attempt to measure TP from DNA expression data (Aran et al., Nature Communications, 6, 2015). However, these methods heavily rely on statistical assumptions and thus cannot be generalized to many forms of sequencing data (Oesper et al., Genome Biology, 14(7): 1, 2013). Furthermore, these methods do not identify whether a mutation is occurring in a subpopulation of cells, an occurrence that can have significant implications. For these reasons, it is advantageous to estimate TP directly from quantitative image analysis.

In Yuan et al. (Science Translational Medicine, 4(157): 157ra143, 2012), the authors proposed a method to measure TP based on quantitative analysis of hematoxylin and eosin (H&E)-stained images of tumor specimens. To do this, they acquired manual annotations by pathologists and used a support vector machine classifier to classify individual nuclei into four different classes (cancer, lymphocyte, stromal, and artifacts), achieving a classification accuracy of 90.1%. They showed that image-based TP estimation is correlated with pathologists' TP scores and demonstrated that quantitative image analysis is useful for improving survival prediction by refining and complementing genomic analysis. However, correlation comparisons may not be enough to decide clinical accuracy, and furthermore, inherent challenges in image analysis such as nuclei detection rate, segmentation accuracy, or imperfect classification rate, which could cause bias in image-based TP estimation, were not explored further.

In this Example, a quantitative image analysis pipeline that includes annotation, segmentation, and classification is described. New methods to provide a systematic comparison between pathologists' TP and image-based TP estimations are also provided. It is envisioned that this framework will allow better understanding of TP estimation based on quantitative image analysis.

FIG. 9 shows an example Quantitative Image Analysis Pipeline, and describes an experimental test that was performed. In the following section, each module of the pipeline is described. Each module can represent, e.g., processor-executable instructions, a control unit, or other computational components described herein with reference to FIG. 13.

Annotation Tool.

In order to collect annotated data from tumor specimens, Cytomine (Maree, Bioinformatics, 32(9): 1395-1401, 2016), an open-source software designed for image-based collaborative studies, was installed on a campus-wide server. H&E whole-slide images (WSI, 20× magnification) of breast cancer tumor specimens obtained and processed at OHSU using the same protocol were uploaded to Cytomine, and annotations were performed by pathologists using Cytomine's web user-interface to annotate individual as well as large regions of nuclei. Annotations and their respective image coordinates were downloaded using Cytomine's Python client. Combined with the segmentation results, individual nuclei were then categorized into “cancer”, “stromal”, “lymphocyte,” and “normal” classes, resulting in a total of 27,863 labeled cancer nuclei and 4,831 non-cancerous nuclei for 10 WSI samples. A subset of 4,831 cancer nuclei was randomly selected out of the 27,863 in order to balance the data for a total of 9,662 labeled nuclei across the 10 WSI images. Other sources of training data can additionally or alternatively be used.

Segmentation.

In this Example, the automatic nuclei segmentation algorithm described in Example 1 was used. In an H&E stained section, hematoxylin stains cell nuclei blue while eosin stains other structures in various shades of red and pink. Since each pixel has a specific intensity and also represents a part of morphological feature(s), by mapping each pixel with useful morphological features and grouping neighboring pixels with similar features, one can differentiate between foreground and background, or between different tissues and nuclei, as described above. Thus, nuclei segmentation can be effectively performed to partition groups of nuclei. In some examples, the algorithm of Example 1 can be used to perform segmentation of other images having similar characteristics.

Training Data Set.

Using the labelled data from pathologists' annotations and individual nuclei masks from the segmentation results, training data sets for supervised machine learning were constructed. Because tumor purity estimation is of interest, segmented nuclei were classified into “cancerous” and “non-cancerous” categories based on the pathologists' annotations; thus stromal, lymphocyte and normal nuclei were merged into the “non-cancerous” nuclei class. Supervised-learning training data can be arranged in other ways to train computational models to perform other classifications or regressions.

Classification.

In order to classify segmented nuclei as cancerous or non-cancerous, supervised classification techniques were used. First, a balanced training data set was used (as described elsewhere herein) and trained an L1-regularized logistic regression (LR) classifier with basic features extracted, e.g., as discussed herein with reference to Example 1. Example features can include intensity and morphology features (area, perimeter, shape indexes, grey level co-occurrence matrices, etc.) extracted from the 9,662 labeled cells. Other types of classifiers or other computational models can additionally or alternatively be used, e.g., neural networks or decision forests.

In a tested example, 90% of the data was used for training the classifier and 10% of the data was held out as a testing set. In order to measure the performance of the classifier on unseen data, 10-fold cross-validation was used, in which for each “fold”, a classifier is trained using 90% of the training data and the model is validated on 10% of the training data. The performance was then calculated as the prediction accuracy on the testing set. Using only intensity and morphology features, 79.0% prediction accuracy was obtained using the above process.

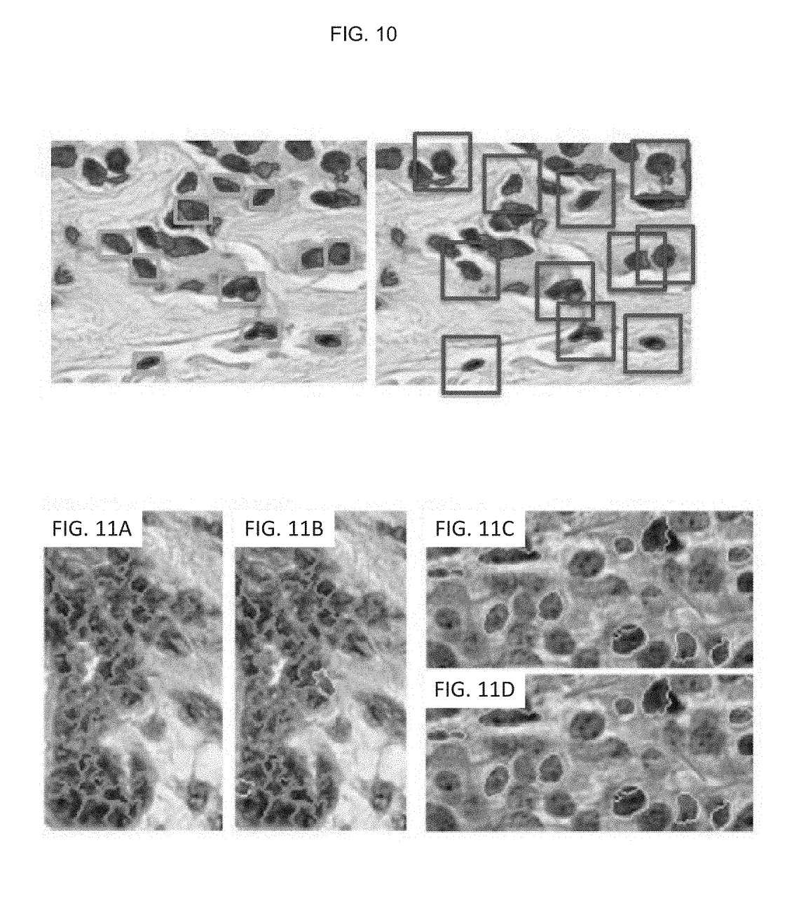

To improve the performance of the classifier, for each nucleus of a plurality of segmented nuclei, texture features extracted from the corresponding segmented nuclei mask were added and the classifier trained again. In order to calculate texture features, a gray-level co-occurrence matrix (GLCM), as discussed above, was calculated based on a patch of pixels of the input image determined by the bounding box of each individual nuclei as shown in FIG. 10 (left), where patch size depends on the size of segmented nuclei; a GLCM describes the second order statistics of pixel pairs located at a given offset. Haralick texture features for each color channel, including contrast, dissimilarity, homogeneity, energy, correlation, and angular second moment (ASM) are then calculated based on each nucleus' GLCM. 82% prediction accuracy was obtained using the testing set.

FIG. 10 shows example nucleus images. In order to extract context-specific texture features, a fixed patch size of 64×64 pixels per individual nucleus was chosen as shown in FIG. 10 (right). This allowed the inclusion of information about the individual nucleuses' environments such as features related to neighboring nuclei and their density. This is inspired by deep learning architecture for feature learning, where some of the input features may include neighboring nuclei information. Following this adjustment in texture feature extraction, 94.5% classification accuracy was obtained using the testing set.

Finally, a support vector machine (SVM) (example training techniques are described in Chang and Lin, ACM Transactions on Intelligent Systems and Technology (TIST), 2(3): 27, 2011, incorporated herein by reference) was also trained using the radial basis function kernel with the same features. All prediction results are summarized in Table 1. Logistic regression (LR) and SVM training can be performed, e.g., using mathematical optimization of objective functions. Example optimization techniques include subgradient descent and coordinate descent. Some SVMs can be trained/determined via quadratic programming.

TABLE 1
Classification results of different classifiers/features
(1: with basic features, 2: with basic + texture features,
and 3: with basic + texture features with fixed patch).

| Classifier | Prediction | Sensitivity | Specificity |
|---|---|---|---|
| LR¹ | 0.79 | 0.80 | 0.78 |
| LR² | 0.82 | 0.84 | 0.80 |
| LR³ | 0.95 | 0.93 | 0.96 |
| SVM³ | 0.99 | 0.98 | 0.99 |

Each model used has parameters that affect the accuracy; in order to achieve maximal training and cross-validation accuracy, a single parameter grid search was performed in which one parameter was calibrated while the others were held at default values and the model was trained. Using this method, 98.4% prediction accuracy was obtained for the training data set. Once the best parameters were determined, overfitting was checked for by testing the model on a testing set. Similar precision accuracy (98.6%) was obtained. A confusion matrix is shown in Table 2 for this testing data set.

FIG. 11 shows the comparison between the ground truth (pathologists' annotation) and the prediction (sampled region of interest; ROI). In FIG. 11, A and C show nuclei annotated with pathologists' labels. B and D show classes predicted by the SVM classifier for the annotated nuclei. Cancerous nuclei are outlined in yellow; non-cancerous nuclei are outlined in cyan. Non-annotated nuclei are not outlined.

TABLE 2
Prediction.

True Diagnosis

| | cancer | non-cancer |
|---|---|---|
| cancer | 479 | 10 |
| non-cancer | 4 | 473 |

Results and Discussion.

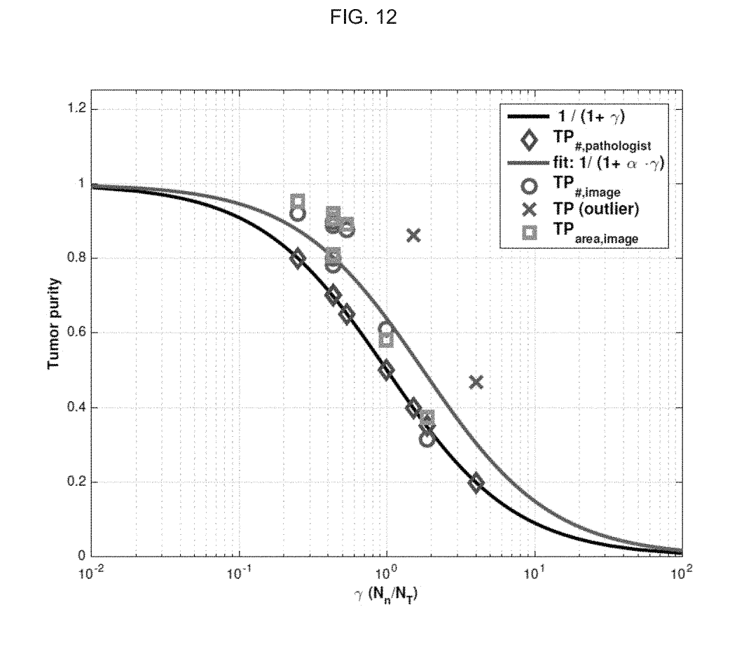

Tumor purity (TP#) can be defined as follows:

$${TP}_{\#} = \frac{{n}_{T}}{{n}_{T} + {n}_{N}} = \frac{1}{1 + γ} \qquad ( 1 )$$

where nT represents the number of tumor cells, nN represents the number of normal cells and the ratio of these numbers is denoted by γ [symbol] n_{N}/n_{T}. For example, if there are three times more normal cells than tumor cells (i.e., γ=3), then there are TP#=0.25. In FIG. 12, the solid black line (“1/(1+γ)”) shows a nonlinear relationship between γ and TP based on (1) and blue diamond marker represents pathologists' tumor purity score across 10 WSI samples where γ is simply calculated based on (1), i.e., γ=(1−TP#)/TP#. Note that semi-log plot (i.e., x-axis is TP# plotted on a logarithmic scale) was used.

With this notion, it can be seen how TP changes according to γ. For example, if TP changes from 0.8 to 0.4 (reduced by half), γ changes from 0.25 to 1.5 (increased by 6 times). Thus, when pathologists examine two different WSI samples which have tumor purity 0.8 and 0.4 respectively, they should see the difference from 0.25 and 1.5 in γ. Similarly, if TP changes from 0.8 to 0.2 (reduced by one-quarter), γ changes from 0.25 to 4 (increased by 16 times). This numerical example illustrates that sensitivity factor of pathologists evaluation may vary over the ranges of γ.

The circle marker in FIG. 12 represents tumor purity estimations from quantitative image analysis showing that the image-based TP estimations are correlated with pathologists' score but overall, the estimation is slightly higher than pathologist's score (note that the cross marker represents outliers, where the WSI includes artifacts, such as tissue folds and bubbles). There could be many possible reasons for this overestimation, such as over-segmentation, overall detection rate, pathologists' bias, etc. In terms of over-segmentation, for example, cancer cells are clustered together in general so a watershed algorithm is used to separate the clustered cells as shown in FIG. 11. However, normal cells such as lymphocytes are not clustered (i.e., not touching each other) so they can be segmented well without any separation. Then, γ could be smaller than the ground truth (thus, higher TP estimation) because there may be more chance to do over-segmentation in tumor cell regions.

In order to provide a systematic comparison between pathologists' scores and the TP estimation, the TP# score was fit with given γ calculated from pathologists' TP score to understand this discrepancy. The fitting function shows TP#=(1+0.5688γ)⁻¹, where 1.7581(=1/0.5688) could be the scaling factor reflecting this over-segmentation. There could be another possibility, for example, pathological scores may reflect primarily the area ratio:

$${TP}_{area} = \frac{{A}_{T}}{{A}_{T} + {A}_{N}} = \frac{1}{1 + \frac{{A}_{N}}{{A}_{T}}} = \frac{1}{1 + \frac{{\overline{a}}_{N} \cdot {n}_{N}}{{\overline{a}}_{T} \cdot {n}_{T}}} = \frac{1}{1 + β \cdot γ} \qquad ( 2 )$$

where A_{T}, A_{N} represent total area covered by tumor and normal cell in tissue section respectively, a T, a N represent mean area size of tumor and normal cell respectively and β=a N/a T reflects the ratio of these numbers. Without loss of generality, we have TP#≤TPₐᵣₑₐ as shown in FIG. 12 where TP_{area,image} (square) is slightly higher than TP#,image (circle). Note that equality holds when mean of tumor cell area size is equal to mean of normal cell area size, i.e., a n=a T. With this notion (i.e., pathologist scores reflect primarily the area of tumor cells seen in a given area), we need to compensate

$$γ ( = \frac{1}{β} \cdot \frac{1 - {TP}_{area}}{{TP}_{area}} )$$

since tumor cell size is bigger than normal cell size

(ā_{N}≤α̅_{T},i.e.,β≤1)

in general.

Example 3 describes development of a quantitative image analysis pipeline for tumor purity estimation. That the TP estimations are correlated with, but (in the tested example) slightly higher than, the estimates from pathologists is demonstrated. To understand inherent challenges in image analysis for improved clinical accuracy, a simple but effective way to provide a systematic comparison is described. In some examples, the image analysis pipelines can be applied on larger data sets.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. A material effect would cause a statistically-significant reduction in ability to reliably and automatically segment nuclei in histopathology images.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or example language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles and other written text throughout this specification (referenced materials herein). The referenced materials are individually incorporated herein by reference in their entirety for their referenced teaching.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art, such as the Oxford Dictionary of Biochemistry and Molecular Biology (Ed. Anthony Smith, Oxford University Press, Oxford, 2004).

1. A system, comprising:
an image-capture device configured to capture an image of a cell population, the image comprising input-pixel values of respective pixels of the image; and
a control unit operatively connected with the image-capture device and configured to:
determine a feature image based at least in part on the input-pixel values, the feature image comprising per-pixel feature values associated with respective pixels of the pixels of the image;
determine a plurality of clusters based at least in part on the feature image, each cluster of the plurality of clusters associated with at least some of the pixels of the image;
select a first cluster of the plurality of clusters, the first cluster associated with nuclei of cells in the cell population;
determine a nuclei mask image representing pixels of the image associated with the first cluster; and
determine a plurality of per-nucleus mask images by applying morphological operations to the nuclei mask image.

2. The system of claim 1, wherein the image-capture device and/or the control unit is configured to carry out one or more operations automatically.

3. The system of claim 1, wherein the image of the cell population is a histopathology image.

4. The system of claim 3, wherein the histopathology image is (a) an image of hemolysin and eosin (H&E) stained tissue section, or (b) an immunohistochemical (IHC) image comprising labeling of a biomarker in a tissue section.

5. The system of claim 1, wherein the image-capture device further is configured to:
(A) determine a response of a Gabor filter based at least in part on a first input-pixel value of a first pixel of the pixels of the image; and
at least one of the per-pixel feature values associated with the first pixel is the response of the Gabor filter;
and/or
(B) determine a response of a Haralick filter based at least in part on a first input-pixel value of a first pixel of the pixels of the image; and
at least one of the per-pixel feature values associated with the first pixel is the response of the Haralick filter;
and/or
(C) determine the plurality of clusters by performing k means clustering of at least some of the super-pixels based at least in part on the per-pixel feature values; and
each of the super-pixels is associated by the k means clustering with exactly one cluster of the plurality of clusters;
and/or
(D) determine respective cytological profiles for a plurality of nuclei represented in the image, each nucleus associated with a respective one of the per-nucleus mask images; and
determine a plurality of nucleus clusters based on the cytological profiles using Landmark-based Spectral Clustering (LSC), wherein each of the plurality of nuclei is associated with one of the plurality of nucleus clusters.

6. The system of claim 5(D), wherein the image-capture device further is configured to:
(1) determine the plurality of nucleus clusters by:
selecting a subset of the cytological profiles, the subset comprising fewer than all of the cytological profiles;
determining a basis based on the subset of the cytological profiles;
determining reduced cytological profiles for respective cytological profiles based on the basis; and
clustering the reduced cytological profiles to provide the plurality of nucleus clusters;
and/or
(2) determine a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity;
and/or
(3) segment nuclei automatically by:
mapping pixels of the image to a point on an n-dimensional feature space;
determining super-pixels including data on one or more chosen features, each super-pixel associated with at least one pixel; and
clustering neighboring pixels with similar features.

7. The system of claim 1, wherein the morphological operations comprise one or more of erosion, dilation, filtering, filling regions, filling holes, maxima/minima transform(s), maxima/minima determination, or watershed transformation.

8. The system of claim 1, wherein the control unit is configured to segment nuclei automatically by:
mapping pixels of the histopathology image to a point on an n-dimensional feature space;
determining super-pixels including data on one or more chosen features, each super-pixel associated with at least one pixel; and
clustering neighboring pixels with similar features.

9. The system of claim 8, wherein at least one super-pixel includes at least one of:
an R, G, B, Panchromatic (broadband), C, M, Y, Cb, Cr, CIE L*, CIE a*, CIE b*, or other data value of or determined based on a corresponding pixel;
a Gabor filter response associated with a corresponding pixel;
a Haralick feature value associated with a corresponding pixel; or
another feature value associated with a corresponding pixel.

10. A computer-implemented method, comprising:
capturing an image of a cell population, the image comprising input-pixel values of respective pixels of the image;
determining a feature image based at least in part on the input-pixel values, the feature image comprising super-pixels associated with respective pixels of the pixels of the image, wherein each super-pixel comprises one or more per-pixel feature value(s) associated with the respective pixel of the pixels of the image;
determining a plurality of clusters based at least in part on the feature image, wherein each cluster of the plurality of clusters is associated with at least some of the pixels of the image;
selecting a first cluster of the plurality of clusters, the first cluster associated with nuclei of cells in the cell population;
determining a nuclei mask image representing pixels of the image associated with the first cluster; and
determining a plurality of per-nucleus mask images by applying one or more morphological operations to the nuclei mask image.

11. The method of claim 10, wherein the method further comprises:
(A) determining a response of a Gabor filter based at least in part on a first input-pixel value of a first pixel of the pixels of the image; and
at least one of the per-pixel feature values associated with the first pixel is the response of the Gabor filter;
and/or
(B) determining a response of a Haralick filter based at least in part on a first input-pixel value of a first pixel of the pixels of the image; and
at least one of the per-pixel feature values associated with the first pixel is the response of the Haralick filter;
and/or
(C) determining the plurality of clusters by performing k means clustering of at least some of the super-pixels based at least in part on the per-pixel feature values; and
each of the super-pixels is associated by the k means clustering with exactly one cluster of the plurality of clusters;
and/or
(D) determining respective cytological profiles for a plurality of nuclei represented in the image, each nucleus associated with a respective one of the per-nucleus mask images; and
determining a plurality of nucleus clusters based on the cytological profiles using Landmark-based Spectral Clustering (LSC), wherein each of the plurality of nuclei is associated with one of the plurality of nucleus clusters.

12. The method of claim 11(D), further comprising:
(1) determining the plurality of nucleus clusters by:
selecting a subset of the cytological profiles, the subset comprising fewer than all of the cytological profiles;
determining a basis based on the subset of the cytological profiles;
determining reduced cytological profiles for respective cytological profiles based on the basis; and
clustering the reduced cytological profiles to provide the plurality of nucleus clusters;
and/or
(2) determining a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity;
and/or
(3) segmenting nuclei automatically by:
mapping pixels of the image to a point on an n-dimensional feature space;
determining super-pixels including data on one or more chosen features, each super-pixel associated with at least one pixel; and
clustering neighboring pixels with similar features.

13. The method of claim 10, wherein the image of a cell population is (a) an image of hemolysin and eosin (H&E) stained tissue section, or (b) an immunohistochemical (IHC) image comprising labeling of a biomarker in a tissue section.

14. The method of claim 10, wherein the morphological operations comprise one or more of erosion, dilation, filtering, filling regions, filling holes, maxima/minima transform(s), maxima/minima determination, or watershed transformation.

15. The method of claim 10, which is a method of:
grading cancer in a subject from which the cell population originated;
diagnosing of cancer in a subject from which the cell population originated; or
estimating tumor purity or determining a tumor purity score for the cell population.

16. A computer-readable medium, having thereon computer-executable instructions, the computer-executable instructions upon execution configuring a computer to perform operations comprising:
capturing an image of a cell population, the image comprising input-pixel values of respective pixels of the image;
determining a feature image based at least in part on the input-pixel values, the feature image comprising super-pixels associated with respective pixels of the pixels of the image, wherein each super-pixel comprises one or more per-pixel feature value(s) associated with the respective pixel of the pixels of the image;
determining a plurality of clusters based at least in part on the feature image, wherein each cluster of the plurality of clusters is associated with at least some of the pixels of the image;
selecting a first cluster of the plurality of clusters, the first cluster associated with nuclei of cells in the cell population;
determining a nuclei mask image representing pixels of the image associated with the first cluster; and
determining a plurality of per-nucleus mask images by applying one or more morphological operations to the nuclei mask image.

17. The computer-readable medium of claim 16, further comprising instructions that, upon execution, configure the computer to perform operations comprising:
(A) determining a response of a Gabor filter based at least in part on a first input-pixel value of a first pixel of the pixels of the image; and
at least one of the per-pixel feature values associated with the first pixel is the response of the Gabor filter;
and/or
(B) determining a response of a Haralick filter based at least in part on a first input-pixel value of a first pixel of the pixels of the image; and
at least one of the per-pixel feature values associated with the first pixel is the response of the Haralick filter;
and/or
(C) determining the plurality of clusters by performing k means clustering of at least some of the super-pixels based at least in part on the per-pixel feature values; and
each of the super-pixels is associated by the k means clustering with exactly one cluster of the plurality of clusters;
and/or
(D) determining respective cytological profiles for a plurality of nuclei represented in the image, each nucleus associated with a respective one of the per-nucleus mask images; and
determining a plurality of nucleus clusters based on the cytological profiles using Landmark-based Spectral Clustering (LSC), wherein each of the plurality of nuclei is associated with one of the plurality of nucleus clusters.

18. The computer-readable medium of claim 16(D), further comprising instructions that, upon execution, configure the computer to perform operations comprising:
(1) determining the plurality of nucleus clusters by:
selecting a subset of the cytological profiles, the subset comprising fewer than all of the cytological profiles;
determining a basis based on the subset of the cytological profiles;
determining reduced cytological profiles for respective cytological profiles based on the basis; and
clustering the reduced cytological profiles to provide the plurality of nucleus clusters;
and/or
(2) determining a first cytological profile of the plurality of cytological profiles for a first cell represented in the image based at least in part on a first mask image of the per-nucleus mask images by measuring one or more features of the pixel(s) of the first mask image, wherein the one or more features are area, major/minor axis length, perimeter, equivalent diameter, a shape index, eccentricity, Euler number, extent, solidity, compactness, circularity, aspect ratio, and/or intensity;
and/or
(3) segmenting nuclei automatically by:
mapping pixels of the image to a point on an n-dimensional feature space;
determining super-pixels including data on one or more chosen features, each super-pixel associated with at least one pixel; and
clustering neighboring pixels with similar features.

19. The computer-readable medium of claim 16, wherein the morphological operations comprise one or more of erosion, dilation, filtering, filling regions, filling holes, maxima/minima transform(s), maxima/minima determination, or watershed transformation.

20. The computer-readable medium of claim 16, which configures the computer to segment nuclei automatically by:
mapping pixels of the histopathology image to a point on an n-dimensional feature space;
determining super-pixels including data on one or more chosen features, each super-pixel associated with at least one pixel; and
clustering neighboring pixels with similar features;
wherein at least one super-pixel includes at least one of:
an R, G, B, Panchromatic (broadband), C, M, Y, Cb, Cr, CIE L*, CIE a*, CIE b*, or other data value of or determined based on a corresponding pixel;
a Gabor filter response associated with a corresponding pixel;
a Haralick feature value associated with a corresponding pixel; or
another feature value associated with a corresponding pixel.
